(19) United States
(12) Patent Application Publication
(10) Pub. No.: US 2026/0191215 A1
(43) Pub. Date: Jul. 9, 2026

(54) Systems and Methods for Optimization of A Cross Flow Membrane Filtration Device

(71) Applicant: GEA Process Engineering A/S, Søborg (DK)

(72) Inventors: Lars Norbert Petersen, København (DK); Christer Utzen, Roskilde (DK); Signe Munch, København (DK)

(21) Appl. No.: 19/129,394

(22) PCT Filed: Nov. 15, 2023
(86) PCT No.: PCT/IB2023/061554

§ 371 Date: May 13, 2025

(30) Foreign Application Priority Data
Nov. 18, 2022 (EP) 22208398.2

(51) Int. Cl. A23C 9/142; B01D 61/14; B01D 61/22

(52) U.S. Cl. CPC A23C 9/1425; B01D 61/145; B01D 61/22; B01D 2313/60; B01D 2313/701; B01D 2313/903; B01D 2315/10

(57) ABSTRACT

The present disclosure relates to a system for optimizing a filtration process performed at a cross flow membrane filtration device. The system comprises an input interface configured to obtain values and disturbances associated with the CFMF device. The system also comprises a control model, which estimates controlled output values, and an optimizer, which updates the state of the control model. The optimizer comprises an MPC layer, which obtains target values and determines new optimal input values for the CFMF device. An output interface causes the optimal values to be output to the CFMF device, optimizing the CFMF process.

### TECHNICAL FIELD

The present disclosure relates to the automation of filtration processes such as ultrafiltration. Particularly, but not exclusively, the present disclosure relates to the automation of a cross flow membrane filtration process for optimization. Particularly but not exclusively, the present disclosure relates to a system for optimizing a filtration process performed at a cross flow membrane filtration (CFMF) device which separates a flow of feed stock and a flow of water into an outlet retentate flow and an outlet permeate flow.

### BACKGROUND

Cross flow membrane filtration (CFMF) is widely used in chemical engineering, biochemical engineering and protein purification for separating components of a feed stock. Depending on the pore size of the filter material, the membrane filtration process is referred to as microfiltration (MF), ultrafiltration (UF), or nanofiltration (NF). The pore size determines the rejection of certain components in the feed and thereby the composition of the final separated streams.

The goal of a CFMF process is to separate a flow of feed into a concentrate flow, also known as a retentate flow, and a permeate flow. It is typically challenging to control the CFMF process such that the percentage value of target components, the target component concentration, in the final product is within a desired range, such as 80.5%±0.5%.

In the dairy industry, cross flow UF and cross flow MF, or a combination of those, are the filtration technologies commonly used in the processing of whey into high-value whey protein concentrates (WPC) and whey protein isolate (WPI). Likewise, UF and MF are well-known technologies to process skimmed milk into milk protein concentrate (MPC) and milk protein isolate (MPI). The UF process separates lactose and minerals (permeate) from the protein (retentate), and concentrates the protein using a membrane which rejects protein and is permeable to lactose, minerals, water etc. For the MF process, the proteins will be in the permeate flow. When, for example, concentrating the protein in the whey, the dry matter ratio increases as well as the total solid components. It is desirable to control the process while optimizing the efficiency of operation to account for feed composition variations and other disturbances. Examples of optimizing the process include: maximizing the production rate; minimizing the water consumption; keeping the quality/concentration of the proteins in the outlet above a minimum limit; and avoiding excess damage in a membrane(s).

The amount of the target component generated depends on a variety of factors, including the concentration factor (feed flow divided by retentate flow), the water flow factor (water flow, also known as diawater flow, divided by feed flow), and the quality of the raw material. Due to variations in the feed composition and issues such as membrane fouling over time, the quality of the raw material is difficult to control and may vary. Therefore, correcting action must be taken by to maintain the target quality. Such correcting action is typically taken by a human operator who monitors the output and varies the concentration and water flow factors. This is a time-consuming task for the operator, which often requires the operator to take samples, analyze these in the laboratory and take subsequent correcting action. This results in the operator ensuing a strategy of running “safe”, which means that the target content must be on-average significantly above a specified quality limit, such that variations will not bring the target content below the quality limit (as illustrated in FIG. 2). Typically, when the protein content resulting from non-optimized CFMF processes are analyzed, the protein content is well above specifications which can result in increased production costs. Recent developments in sensor technology have made it possible to install in-line composition sensors, eliminating the need for manual samples and laboratory work. However, the operator is still required take manual action to correct the process to reach the quality specifications.

Overall, this standard operator-based corrective process is time consuming, inefficient, and can result in a higher environmental impact, such as a higher carbon footprint. One of the reasons for a higher environmental impact is the often higher-than-necessary amounts of water and energy utilized in order to fulfill the required quality-related requirements of the final product.

There is a general need for a more efficient control, allowing prompt changes during the process to compensate for varying disturbances and composition of the raw material.

### SUMMARY OF DISCLOSURE

The disclosure is directed towards a system for more efficient control over a CFMF process. Optimizing the CFMF process involves using CFMF-associated data, such as data obtained from sensors installed in the components of a CFMF device, to predict these same values at future time points, and therefore adjust input values of the process (e.g, a concentration factor and a water factor) in order to reach the desired protein content.

One aspect of the present disclosure relates to a system for optimizing a filtration process performed at a CFMF device, which separates a flow of feed stock and a flow of water into an outlet retentate flow and an outlet permeate flow. The system comprises an input interface, which is communicatively coupled to the CFMF device, configured to obtain a plurality of controlled output values associated with the filtration process performed at the CFMF device and obtain a plurality of disturbances associated with the CFMF device. The plurality of controlled output values comprise: (i) a product concentration value indicative of concentration of a target component of the feed stock in the outlet product flow, and (ii) a total concentration value indicative of concentration of solid components in the outlet product flow. The product flow may comprise a permeate and/or retentate flow. For example, (i) may be a retentate concentration value indicative of concentration of protein in the outlet retentate flow, and (ii) may be a total concentration value indicative of concentration of all solid components in the outlet retentate flow.

The system further comprises a control model of the CFMF device, wherein the control model estimates controlled output values from input values according to a state of the control model and the plurality of disturbances. The system also comprises an optimizer, wherein the optimizer is configured to update the state of the control model based on the plurality of controlled output values. The optimizer comprises a model predictive control (MPC) layer, wherein the MPC layer is configured to obtain a plurality of target controlled output values and determine a plurality of input values. The plurality of input values optimize a first difference between the plurality of target controlled output values and a plurality of estimated controlled output values, wherein the plurality of estimated controlled output values are determined from the control model using the plurality of input values. The system further comprises an output interface communicatively coupled to the CFMF device, which is configured to cause the plurality of input values to be output to the CFMF device. This results in the decreasing of a second difference between the plurality of target controlled output values and a future plurality of controlled output values.

Beneficially, the optimizing system includes a control model and an MPC layer, which allows for continuous automation to monitor and correct the CFMF process. This can then result in a significant optimization of the target component concentration in the output product. For example, applying the optimizing system to dairy cross flow UF can result in a more consistent product being obtained, with a reduction in the variation of the protein content over time. Therefore, when compared to non-optimized human CFMF systems the average protein content is closer to the target content without compromising quality of the end product. For example, where the target protein content is 80%, a non-optimized CFMF device for isolating whey protein may produce a product with an average protein content of greater than 85% protein, while an optimized CFMF device may average closer to 80% but never below 80%. This results in a more efficient CFMF process, with less wasted feed stock, water, energy, and time.

According to another aspect of the present disclosure, the disclosed relates to a system for optimizing water consumption at a CFMF device comprising a plurality of membranes each of which performing a filtration process which separates a flow of feed stock and a flow of water into an outlet retentate flow and an outlet permeate flow. Optimizing the total water consumption can be achieved by acquiring an optimal split of the water to each membrane stack, wherein there is a plurality of stacks. The stacks may comprise any of any form of filtration membrane, such as membranes for UF and membranes for MF, or a combination thereof. This optimal split process allows for better water utilization in the CFMF, which can also reduce the total amount of water required. Also by reducing the amount of water used, the resultant retentate has a lower water content, which reduces the amount of energy required in post-processing processes such as drying.

The system comprises a membrane control model associated with the plurality of membranes, wherein the membrane control model is configured to estimate a concentration value based on an input flow of water to each of the plurality of membranes, the permeate flow at each stack, the retentate flow, and/or the retentate composition. The concentration value is therefore associated with an estimated concentration of solid components in the retentate flow of each stack. The system further comprises an optimization unit configured to obtain an optimal concentration value associated with solid components in the retentate flow of each stack. The optimization is further configured to determine an optimal input flow of water for each of the plurality of membranes, which minimizes a difference between the optimal concentration value and an estimated concentration value. The estimated concentration value is determined from the membrane control model based on the optimal input flow of water for each of the plurality of membranes. The system further comprises an output interface communicatively coupled to the CFMF device and configured to cause the CFMF device to adjust the flow of water at each of the plurality of membranes of the CFMF device according to the optimal input flow of water determined for each of the plurality of membranes.

Beneficially, the optimization unit and membrane control model allow for an automated system that can continually monitor and respond to changes in the water flow and important concentration values. This is an improvement over a non-optimized system, as it results in the optimal water flow and concentration values, leading to increased CFMF process performance and, simultaneously, membrane optimization. The water consumption is potentially reduced significantly, improving both efficiency and environmental impacts of the CFMF process.

According to another aspect of the present disclosure, the disclosed relates to a system for optimizing a filtration process performed at CFMF device. The CFMF device comprises a plurality of membranes, each of which performing a filtration process, which separates a flow of feed stock and a flow of water into an outlet retentate flow, and an outlet permeate flow. The system comprises an input interface communicatively coupled to the CFMF device and configured to obtain a plurality of controlled output values associated with the filtration process performed at the CFMF device and obtain a plurality of disturbances associated with the CFMF device. The plurality of controlled output values may comprise: (i) a product concentration value indicative of concentration of a target component of the feed stock in the outlet product flow, and (ii) a total concentration value indicative of concentration of components in the outlet product flow.

The product flow may comprise a permeate and/or retentate flow. For example, (i) may be a retentate concentration value indicative of concentration of protein in the outlet retentate flow, and (ii) may be a total concentration value indicative of concentration of all solid components in the outlet retentate flow. The system further comprises a device control model associated with the CFMF device, wherein the device control model estimates controlled output values from input values according to a state of the device control model and the plurality of disturbances, and a membrane control model associated the plurality of membranes, wherein the membrane model is configured to estimate a concentration value based on at least an input flow of water to each of the plurality of membranes. The concentration value is associated with an estimated concentration of solid components in the retentate flow.

The system additionally comprises an optimizer, wherein the optimizer is configured to update the state of the device control model based on the plurality of controlled output values. The optimizer further comprises a model predictive control (MPC) layer and a water flow optimization (WFO) layer. The MPC layer is configured to obtain a plurality of target controlled output values and determine a plurality of input values which optimize a first difference between the plurality of target controlled output values and a plurality of estimated controlled output values. The plurality of estimated controlled output values are determined from the device control model using the plurality of input values. The WFO layer is configured to obtain an optimal concentration value associated with solid components in the outlet retentate flow; determine an optimal water factor associated with an input flow of water for each of the plurality of membranes, which minimizes a difference between the optimal concentration value and an estimated concentration value, wherein the estimated concentration value is determined from the membrane control model based on the optimal input flow of water for each of the plurality of membranes; and adjust the plurality of input values determined by the MPC layer based on the optimal input flow of water for each of the plurality of membranes. The system further comprises an output interface, which is communicatively coupled to the CFMF device, configured to cause the plurality of input values to be output to the CFMF device. This results in a decreasing of a second difference between the plurality of target controlled output values and a future plurality of controlled output values.

Beneficially, the optimizing system includes a control model and an MPC layer, which allows for continuous automation to monitor and correct the CFMF process, and an optimization unit and membrane control model allow the automated system to monitor and respond to changes in the water flow, among other factors, such as changes in feed composition. This can then result in a significant optimization of the target component concentration in the output product while also resulting in water conservation and optimization of the membrane(s) lifetime, preventing early fouling. This significantly increases the efficiency of the CFMF process, with less wasted feed stock, water, energy, and time, while reducing the environmental impact of the CFMF process.

Additional aspects and embodiments of the present systems are disclosed, and the above aspects and embodiments should not be construed as limiting the present disclosure.

### BRIEF DESCRIPTION OF DRAWINGS

To facilitate a fuller understanding of the present disclosure, reference is now made to the accompanying drawings, in which like elements are referenced with like numerals. These drawings should not be construed as limiting the present disclosure, but are intended to be illustrative only.

FIG. 1 shows illustrations of reverse osmosis, UF, and MF membranes.

FIG. 2 shows an illustration of an example optimized CFMF system.

FIG. 3 shows a representative trace showing the target component concentration over time, where the CFMF process is conventional (non-optimized), stabilized, and then optimized over separate time zones.

FIG. 4 shows a high-level system architecture diagram in accordance with the present disclosure for optimizing a filtration process performed at a CFMF device.

FIG. 5 shows a high-level system architecture diagram in accordance with the present disclosure for optimizing water consumption at a CFMF device.

FIG. 6 shows a high-level system architecture diagram in accordance with the present disclosure for optimizing both a filtration process and water consumption associated with a CFMF device.

FIG. 7 shows a flowchart illustrating a method for optimizing a filtration process performed at a CFMF device.

FIG. 8 shows a flowchart illustrating a method for optimizing water consumption at a CFMF device.

FIGS. 9A and 9B shows a flowchart illustrating a method for optimizing a filtration process and water consumption at a CFMF device.

FIG. 10 shows an example computing system for optimization according to embodiments of the present disclosure.

### DETAILED DESCRIPTION

The description below discloses an automated control algorithm configured to operate while a cross flow membrane filtration (CFMF) process is running. The algorithm is further configured to continuously, such as every time interval of 30 seconds, obtain values based on the CFMF process. The algorithm contains a model predictive control (MPC) algorithm, which is used to compute a new set of optimal values to compensate for any disturbances in the CFMF process, such as the composition of the raw material. The objective of the algorithm is to decrease the variation in the target variable produced, such as protein, and the total solids concentration of the concentrate.

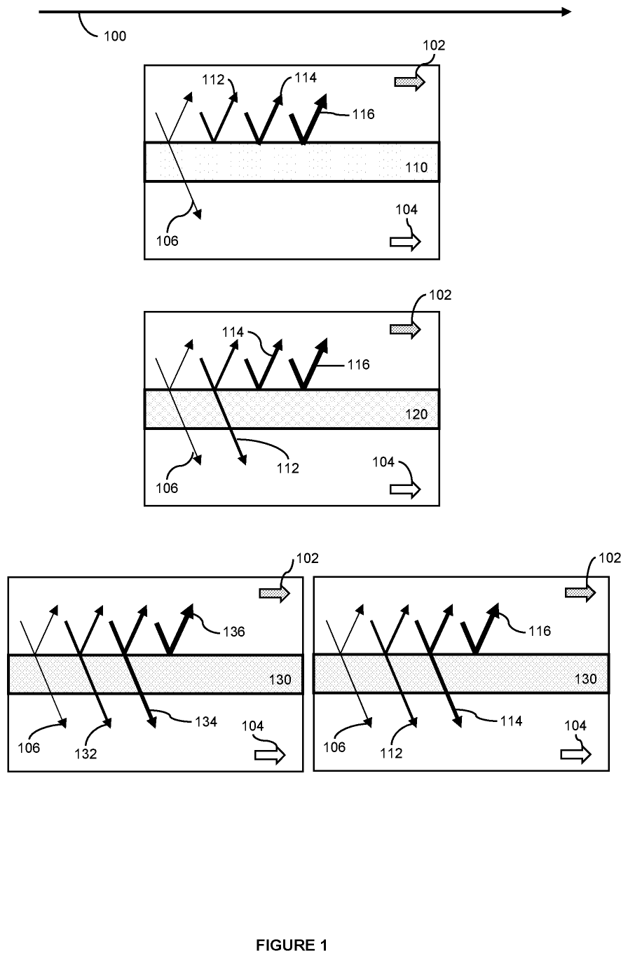

FIG. 1 illustrates three example types of CFMF processes, where the feed stock 100 travels from the left to the right of FIG. 1.

FIG. 1 shows three membranes, including a reverse osmosis membrane 110, an UF membrane 120, and a MF membrane 130. FIG. 1 further shows a flow of components, including: an outlet retentate flow 102; an outlet permeate flow 104; and water 106 associated with each membrane. FIG. 1 further includes: salts, sugars, and low molecular width compounds 112; fats and proteins 114; larger molecules or microorganisms 116; lactose and minerals 132; casein and whey proteins 134; and bacterial cells 136.

The feed stock 100 encounters a reverse osmosis membrane 110, an UF membrane 120, or a MF membrane 130. The feed stock 100 is split by the cross flow membrane filtration process into an outlet retentate flow 102 and an outlet permeate flow 104. The outlet retentate flow 102 comprises components that have not permeated the membrane. The outlet permeate flow 104 comprises components that have permeated the membrane.

Water 106 can permeate the reverse osmosis membrane 110. However, salts, sugars, and low molecular width compounds 112; fats and proteins 114; and larger molecules or microorganisms 116 do not permeate the reverse osmosis membrane 110. Therefore, the outlet permeate flow 104 may comprise only water 106. The outlet retentate flow 102 may comprise any of the components of the feed stock 100.

Water 106 can permeate the UF membrane 120, as can salts, sugars, and low molecular width compounds 112. However, fats and proteins 114 and larger molecules or microorganisms 116 do not permeate the UF membrane 120. Therefore, the outlet permeate flow 104 may comprise any of water 106 and salts, sugars, and low molecular width compounds 112.

Water 106 can permeate the MF membrane 130, as can salts, sugars, and low molecular width compounds 112 and fats and proteins 114. However, larger molecules or microorganisms 116 do not permeate the MF membrane 130. Therefore, the outlet permeate flow 104 may comprise any of water 106, salts, sugars, and low molecular width compounds 112, and fats and proteins 114. By tailoring the size of pores of the MF membrane, fats and proteins 114 can be separated from each other, the fats not permeating the MF membrane 130 while the proteins permeating the membrane 130 together with water 106 and salts, sugars, and low molecular width compounds 112.

In one example, the feed stock 100 comprises a dairy product, such as skim milk. Therefore, the feed stock 100 comprises the following components: water 106; lactose and minerals 132; casein and whey proteins 134; and bacterial cells 136. Water 106 can permeate the microfiltration membrane 130, as can lactose and minerals 132 and casein and whey proteins 134. Bacterial cells 136 do not permeate the ultrafiltration membrane. Therefore, the outlet permeate flow 104 may comprise any of water 106, lactose and minerals 132, and casein and whey proteins 134. This process is described in more detail below.

MF membrane 130, UF membrane 120, reverse osmosis membrane 110, and/or NF membrane (not depicted) can be used independently or in combination. They can also be used as part of a membrane stack, or in combination with other filtration techniques or processes, such as ion-exchange. Each membrane can be tailored to specific porosity, and membrane stacks can be tailored for specific process and to have certain porosity ranges. For the processing of whey into high-value whey protein concentrates (WPC), an UF process of whey in generally employed, while for the processing of high-value whey protein isolate (WPI), which is a pure and almost fat-free WPC, a combination of UF and MF is used. The purpose of MF is the further separation of fat from the proteins. Likewise, UF is employed for the extraction of milk protein concentrate (MPC) from skimmed milk, while a combination of UF and MF are used for the extraction of milk protein isolate (MPI) from skimmed milk. Examples therefore include using UF to obtain WPC from whey; a combination process of UF, MF, and UF to obtain WPI from whey; UF to obtain MPC from skimmed milk; a combination process of MF and UF to obtain MPI from skimmed milk; MF to separate caseins and whey from skimmed milk; and a process of ion-exchange and nanofiltration to obtain lactoferrin from whey.

In more detail, pasteurized skimmed milk can be processed using MF/diafiltration to form a retentate of caseins, residual whey proteins, lactose, and minerals. Micellar casein can be obtained from this retentate. The permeate may comprise whey protein, lactose, and minerals. This permeate can be processed using UF/diafiltration to form a further retentate of whey proteins, residual lactose, and minerals, which can be used to obtain milk whey proteins. The final permeate may comprise lactose and minerals.

In a different example, feed stock 100 may comprise a plant-based protein solution, where the proteins come from raw materials such as oat, rice, soya, nuts, peas, beans, etc. In this example, water 106 can permeate the UF membrane 120, as can plant-based sugars and minerals (e.g. salts, sugars, and low molecular width compounds 112), however plant-based fats and proteins (e.g. fats and proteins 114) do not permeate the UF membrane. If a purer and almost fat-free protein concentrate shall be produces, a further MF stage will be used in combination with the UF membrane in order to reduce the fats from the protein concentrate.

In another example, feed stock 100 may comprise animal-based protein solution, where the proteins originate from example from fish or other animals, for example chicken, pig, cow, etc.

The invention, as described below, can be applied to any of these processes, or to any other applications where purification by filtration and diafiltration is performed.

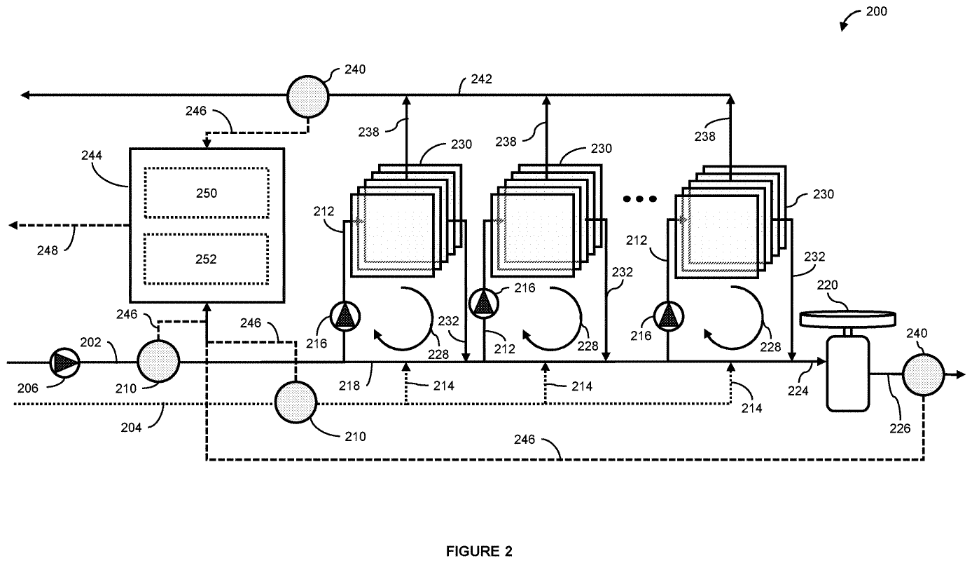

FIG. 2 shows an optimized CFMF system 200 in accordance with the present invention.

Specifically, FIG. 2 illustrates a system architecture diagram in accordance with an example optimized CFMF device. The CFMF system 200 represents an optimized CFMF device, wherein the CFMF system is configured to reduce the amount of consumables required in obtaining a resulting product of a set target quality. Furthermore, the CFMF system 200 in configured to ensure that the resultant product is a close to the set target quality as possible, without dropping below the set target quality.

CFMF system 200 comprises a feed stock 202, a water flow 204, and a pump 206. CFMF system 200 further comprises sensor 210, backpressure valve 220, one or more membrane stacks 230, and sensor 240. CFMF system 200 also comprises input feed stock 212, input water flow 214, input pump 216, retentate flow 232, outlet retentate flow 218, permeate flow 238, pre-valve outlet retentate flow 224, post-value outlet retentate flow 226, flow direction 228, and outlet permeate flow 242. The individual components of the CFMF system 200 described above with reference to FIG. 2 are known commercially available components whose functionality need not be described further.

CFMF system 200 further comprises an optimization control unit 244, CFMF-associated output values 246, and control unit values 248. Optimization control unit 244 may further comprise device optimization unit 250 and/or water optimization unit 252.

A portion of the feed stock 202 (e.g. feed stock 100 of FIG. 1) flows towards the membrane stack 230 as illustrated in input feed stock 212. Feed stock 202 may be pumped by pump 206 and input feed stock 212 may be pumped by input pump 216. The composition and flow of feed stock 202 may be monitored with sensor 210, for example a flow sensor and/or a composition sensor, such as a hall-effect sensor, an optical-based sensor, or a sonar-based sensor. A portion of the water flow 204 (e.g. water 106 of FIG. 1) flows towards the membrane stack 230 as illustrated in input water flow 214. Membrane stack 230 comprises at least one membrane (e.g. UF membrane 120 and/or MF membrane 130 of FIG. 1). For example, fats and proteins do not permeate through the membrane stack 230 and merge together forming a retentate flow 232 (e.g. outlet retentate flow 102 of FIG. 1). Water, salts, sugars, and low molecular width compounds would permeate through the membrane stack 230 and merge together forming outlet permeate flow 242 (e.g. outlet permeate flow 104 of FIG. 1). The composition and flow of outlet permeate flow 242 may be monitored with sensor 240 and/or sensor 210. The sensor 240/sensor 210 may be installed at any point in the CFMF system 200, and may be configured to measure the composition and/or the flow of the related component (e.g. measurement of protein or total solids percentage of the product in the feed stock 202 and retentate flow 232). The retentate flow 232 may form input feed stock 212 such that there is a circular flow direction 228 between the outlet retentate flow 218 and the membrane stack 230.

The backpressure valve 220 is configured to reduce the pre-valve outlet retentate flow 224 to a defined value given by the concentration factor (CF). The CF is the ratio between the pre-valve outlet retentate flow 224 and the feed stock 202 flow. The pre-valve outlet retentate flow 224 then becomes the post-valve outlet retentate flow 226, which is also known as the outlet concentrate flow. For example, the backpressure valve 220 may be configured so the portion of pre-valve outlet retentate flow 224 flowing out of the CFMF system, post-valve outlet retentate flow 226, is 50% of the total feed stock 202, and so the total permeate flow, outlet permeate flow 242, is 50% of the feed stock 202 plus the water flow 204 passing through the membrane stack(s) 230. Further configurations are possible, such that post-valve outlet retentate flow 226 may comprise any percentage between 0% and 100% of feed stock 202 flow. Optionally, backpressure valve 220 is a plurality of backpressure valves.

The sensor 240 may be installed at any point in the retentate flow 232 of the last stack or any previous stack, in the pre-valve outlet retentate flow 224, or in the post-valve outlet retentate flow 226, or in the outlet permeate flow 242. The sensor 240 is configured to measure the composition of the related component (e.g. measurement of protein, lactose, fat, ash and/or total solids as a percentage of the product) at the particular point in the retentate flow 232.

Optimization control unit 244 may comprise device optimization unit 250 and/or water optimization unit 252. Device optimization unit 250 can optimize the CFMF system 200m, including the water flow 204, while water optimization unit 252 can optimize the input water 214 and therefore the relative quantity of water provided to each membrane stack 230. Consequently, device optimization unit 250 and water optimization unit 252 may be combined or used individually.

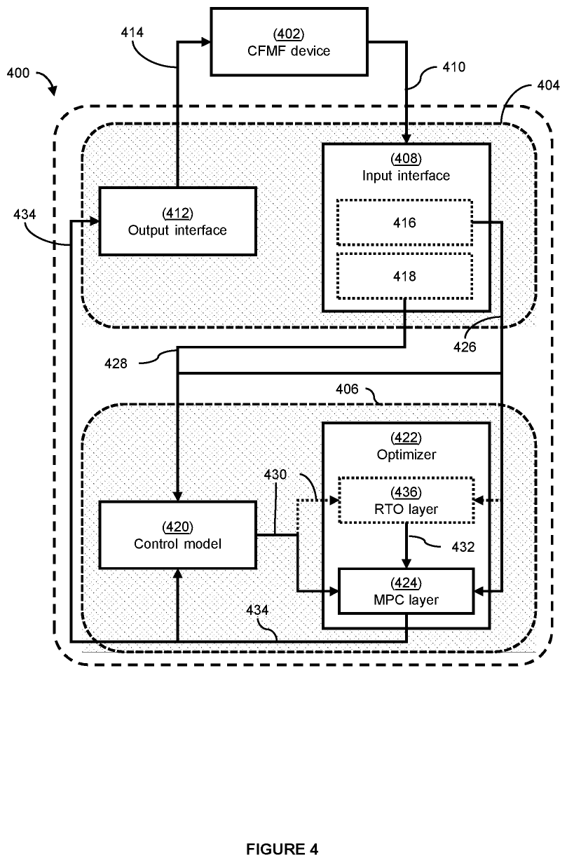

Optimization control unit 244 is configured to obtain CFMF-associated output values 246, wherein the CFMF-associated output values 246 are a plurality of values associated with the CFMF system 200. For example, values can include controlled output values such as any of: a retentate concentration value indicative of concentration of a target component of the feed stock 202 in the post-valve retentate flow 226; a permeate concentration value indicative of concentration of a target component in the outlet permeate flow 242; and a total concentration value indicative of the concentration of solid components in the post-valve retentate flow 226. Values can also include disturbance values, measured by sensor 210 and/or sensor 240, which may comprise any of air temperature, feed stock temperature, or feed solids concentration. Values related to concentration may be based on a plurality of filter specifications associated with membrane stack 230, wherein each of the plurality of filter specifications comprises a water permeability of an associated membrane, solute concentration of the associated membrane, the solute permeability of the associated membrane, the reflection coefficient of the associated membrane, and a membrane area of the associated membrane which can be used to calculate pressure (e.g. hydrodynamic pressure difference and/or osmotic pressure difference). CFMF-associated output values 246 may be obtained from sensor 210, sensor 240, or sensors not depicted in FIG. 2, such as soft-sensors, which will be described in more detail below in relation to FIG. 4.

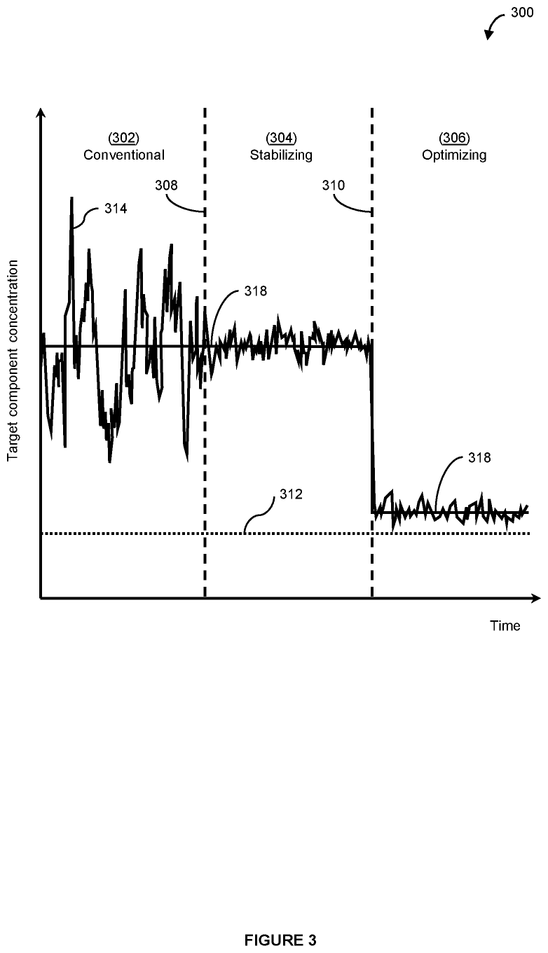

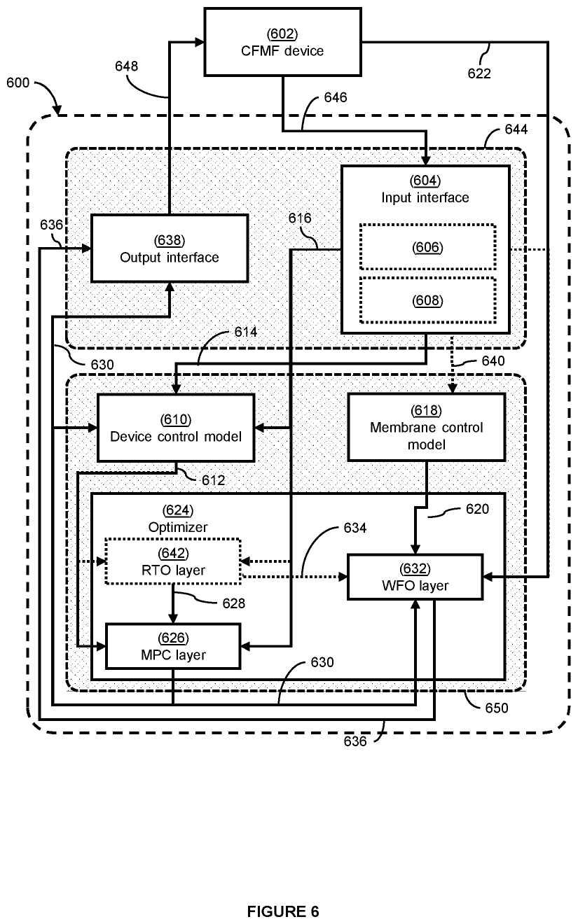

Optimization control unit 244 is further configured to output control unit values 248. Control unit values 248 may comprise optimal input values for the CFMF system 200, wherein the optimal input values for the CFMF system 200 are input values for the CFMF system 200 that would improve the efficiency of the CFMF system 200. For example, control unit values 248 may be used by the CFMF system 200 to result in alterations to the backpressure valve 220 configuration or changes to the water flow 204 input to the membrane stack 230 relative to the feed stock 202. Beneficially, optimization control unit 244 would therefore adjust the levels of input water 214 and outlet product flow to a target quality in the resulting product. This can reduce the energy required to obtain a free-flowing powder in a later process, as less water requires evaporating. The functionality of optimization control unit 244 is described in detail below in reference to FIG. 6. Specifically, optimization control unit 244 may be system 600 of FIG. 6. An example impact of optimization control unit 244 is shown in graph 300 of FIG. 3.

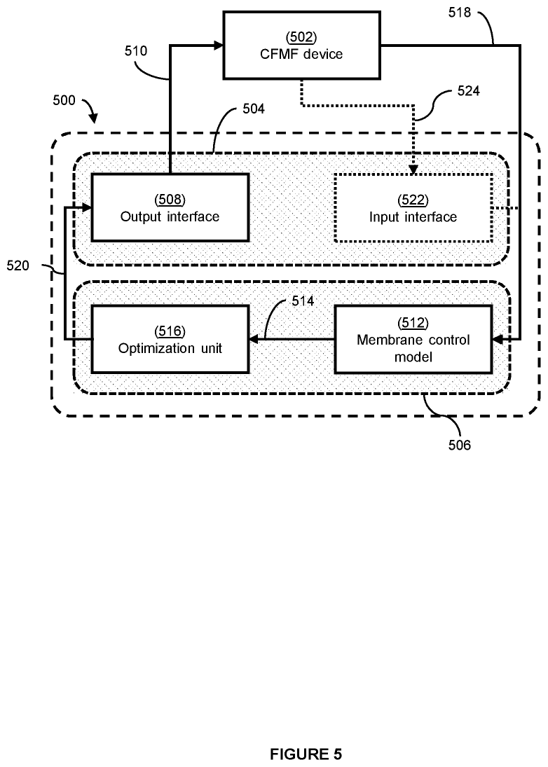

Optimization control unit 244 may further comprise of at least one of device optimization unit 250 or water optimization unit 252. In one example, optimization control unit 244 comprises both device optimization unit 250 and water optimization unit 252. Device optimization unit 250 is configured to use CFMF-associated output values 246 to predict these same values at future time points, and therefore adjust input values of the process, control unit values 248, in order to reach the desired target component content. This can result in fast, automated, and efficiency-improving adjustments to CFMF-related variables, such as backpressure value configuration. The functionality of device optimization unit 250 is described in detail below in reference to FIG. 4. Specifically, device optimization unit 250 may be optimizing system 400 of FIG. 4. Water optimization unit 252 is configured to determine an optimal input flow of water for each membrane stack 230, which minimizes a difference between a target concentration value, such as an optimal concentration value, and a predicted concentration value at a future time point, and subsequently output the optimal input flow, which is included in control unit values 248. This can result in fast, automated, and efficiency-improving adjustments to, for example, water flow 204. The functionality of water optimization unit 252 is described in detail below in reference to FIG. 5. Specifically, water optimization unit 252 may be water optimizing system 500 of FIG. 5.

Preferably, CFMF system 200 may include a plurality of membrane stacks 230, which are not depicted here. The plurality of membrane stacks 230 may be configured in series or in parallel, for example feed stock 202 may flow to the plurality of membrane stacks 230 using a plurality input feed stocks 212, or feed stock 202 may flow to the plurality of membrane stacks 230 using a single input feed stock 212. The plurality of membrane stacks 230 may be configured in a combination of parallel and series. Additionally, the CFMF system 200 may comprise multiple filtration stages, wherein feed stock 202 loops through at least one of the plurality of membrane stacks 230. In one, feed stock 202 and water flow 204 flowing out of the CFMF system 200 forms at least part of a feed stock 202 and water flow 204 flowing towards a membrane stack, such that the CFMF process is repeated. Outlet permeate flow 242 may be a plurality of outlet permeate flows from a plurality of membrane stacks not depicted here. Outlet permeate flow 242 may become feed stock 202 for another CFMF process, and post-valve outlet retentate flow 226 may become feed stock 202 for another CFMF process.

In another example, CFMF system 200 may further comprises any of: one or more pumps, for example pumps may pump feed along the direction of feed stock 202 and/or input feed stock 212; one or more stage coolers, for example the stage cooler may cool retentate flow 232; one or more heaters, for example the heater may heat the feed stock 202; and a feed tank, for example feed stock 202 may flow from the feed tank. In another example, any of pre-valve outlet retentate flow 224, post-valve retentate flow 226, or outlet permeate flow 242 may flow into the feed tank.

Optionally, feed stock 202 and water flow 204 are combined, and/or input feed stock 212 and input water flow 214 are combined. Sensor 210 may be combined with sensor 240, and pump 206 may be combined with input pump 216. Alternatively, there may be a plurality of sensors 210, sensors 240, pumps 206 and input pumps 216.

One example usage of CFMF system 200 is processing of whey into high-value WPC, wherein feed stock 202 comprises a dairy product whey, and a target component comprises whey protein. Another example is the usage of the CFMF system 200 to produce milk protein concentrate, wherein the feed stock 202 comprises a dairy product, for example skim milk, and a target component comprises milk protein. Other example target components may include: whey protein concentrate, whey protein isolate, milk protein concentrate, milk protein isolate, micellar casein concentrate, micellar casein isolate, and lactoferrin. Alternatively, feed stock 202 may comprise a plant-based protein solution, where the proteins come from raw materials such as oat, rice, soya, nuts, peas, or beans. The target component can subsequently comprise associated proteins or fats.

Alternatively, feed stock 202 may comprise an animal-based protein solution, where the proteins originate from example from fish or other animals, for example chicken, pig, cow, etc. The target component can subsequently comprise associated proteins or fats.

FIG. 3 shows a graph 300 of target component concentration over time.

Graph 300 comprises three time periods, including a conventional CFMF process period 302, a stabilizing CFMF process period 304, and an optimizing CFMF process period 306. These are separated by two dashed lines, a first time line 308 and a second time line 310. Graph 300 further comprises optimal target line 312, a target component concentration trace 314, and an average target component concentration line 318.

The time at which the conventional CFMF process period 302 changes to the stabilizing CFMF process period 304 is shown by the first time line 308. The time at which the stabilizing CFMF process period 304 changes to the optimizing CFMF process period 306 is shown by the second time line 310.

Before the first time line 308, the range of the target component concentration trace 314 is greater than after the first time line 308.

Optimal target line 312 shows an optimal target component concentration desired from the CFMF process. The average target component concentration line 318 represents the mean average of the target component concentration trace over a time zone.

In graph 300, average target component concentration line 318 is the same during the conventional CFMF process period 302 and the stabilizing CFMF process period 304 showing that the stabilizing the CFMF process 304 may not necessarily result in target composition closer to the optimal amount. This also illustrates how conventional methods, such as using an operator to make adjustments, and prior art stabilization methods, such as using sensor technology, may result in a “safe” strategy where the average target concentration is significantly above a specified quality limit, thereby resulting in increased levels of required water and energy. In contrast, during the optimizing CFMF process period 306 the output is closer to the optimal target line 312. Additionally, the optimizing CFMF process period 306 may result in further efficiency benefits. For example, the optimizing CFMF process period 306 may result in reduced required water levels, and such improvements to water optimization may result in less water evaporation required and hence less required energy.

The optimizing CFMF process period 306 may be a time period where the optimizing systems as described below with reference to FIG. 4, FIG. 5, or FIG. 6 are in effect, or the optimization control unit 244 of FIG. 2. In the scenario shown in graph 300, average target component concentration line 318 during the conventional CFMF process period 302 and the stabilizing CFMF process period 304 is substantially above the optimal target line 312. Therefore, these time zones are less efficient than during the optimizing CFMF process period 306, where the average target component concentration line 318 is closer to the optimal target line 312 and the optimal component concentration, showing how the optimizing systems of FIG. 2, FIG. 4, FIG. 5, or FIG. 6 improve efficiency.

Additionally, the CFMF processes of FIG. 3 may be performed using CFMF system 200 of FIG. 2. For example, the target component concentration is the concentration of whey protein detected using sensor 240 of FIG. 2, and target component concentration trace 314 is the concentration of whey protein obtained from outlet permeate flow 242 of FIG. 2, and the optimization process is performed using optimization control unit 244.

One aspect of the present disclosure relates to the optimizing system of FIG. 4.

FIG. 4 shows an optimizing system 400 and a CFMF device 402. The optimizing system 400 comprises an interface unit 404 and a control unit 406. The interface unit 404 further comprises an input interface 408, connection 410, output interface 412, and connection 414. The input interface 408 may further comprise an interface for the input of disturbance values 416 and controlled output values 418. The control unit 406 further comprises a control model 420 and an optimizer 422. The optimizer 422 further comprises a model predictive control (MPC) layer 424. The optimizing system 400 further comprises plurality of disturbance values 426, plurality of controlled output values 428, a state of the control model 430, target controlled output values 432, and optimal input values 434.

The optimizing system 400 is a system for optimizing a filtration process performed at a CFMF device 402 which separates a flow of feed stock and a flow of water into an outlet retentate flow and an outlet permeate flow. The optimizing system 400 for the CFMF device 402 comprises an input interface 408 communicatively coupled to the CFMF device 402. The input interface 408 is configured to obtain a plurality of controlled output values 418 associated with the filtration process performed at the CFMF device. The plurality of controlled output values may comprise (i) a product concentration value indicative of concentration of a target component of the feed stock in the outlet product flow, and (ii) a total concentration value indicative of concentration of solid components in the outlet product flow. The product flow may comprise a permeate and/or retentate flow. For example, (i) may be a retentate concentration value indicative of concentration of protein in the outlet retentate flow, and (ii) may be a total concentration value indicative of concentration of all solid components in the outlet retentate flow. Input interface 408 is further configured obtain a plurality of disturbance values 416 associated with the CFMF device 402.

Controlled output values 418 are values associated with the CFMF device 402 at a given time that can be controlled by either manual or automated intervention in the CFMF process. For example, controlled output values 418 are values related to composition of the outlet product flow (retentate or permeate flow). Controlled output values 418 may comprise any of: a product concentration value indicative of concentration of a target component of the feed stock in the outlet product flow; and a total concentration value indicative of the concentration of solid components in the outlet product flow. Feed stock may be feed stock 202 and outlet product flow may be retentate flow 232 or post-valve outlet retentate flow 226 of FIG. 2. Alternatively or additionally, feed stock may be input feed stock 212 and outlet product flow may be permeate flow 238 or outlet permeate flow 242 of FIG. 2.

Disturbance values 416 are typically values at a given time associated with the CFMF device 402 that are not easily controlled. For example, disturbance values 416 may be values relating to the conditions at any point within or around the CFMF device 402, or values relating to the quality of consumables entering the CFMF device 402 as part of the CFMF process. Disturbance values 416 may comprise, for example, any of air temperature, feed stock temperature, or feed solids concentration. Other suitable disturbance values 416 may be identified and used in accordance with the operating conditions of the system.

The optimizing system 400 for the CFMF device 402 further comprises a control model 420 of the CFMF device 402, wherein the control model estimates controlled output values according to a state of the control model 430 from plurality of controlled output values 428 and the input plurality of disturbance values 426. The state of the control model 430 is an augmented version of the CFMF device 402 at a given time. For example, an augmented version of the CFMF device 402 can be determined using controlled output values 428 and the input plurality of disturbance values 426. The estimated controlled output values according to the state of the control model 430 are subsequently augmented controlled output values that correspond to the augmented version of the CFMF device for a given time point.

The optimizing system 400 for the CFMF device 402 further comprises an optimizer 422 comprising a model predictive control (MPC) layer 424, wherein the optimizer 422 is configured to update the state of the control model 430 based on the plurality of controlled output values 428. The MPC layer 424 is configured to: obtain a plurality of target controlled output values 432; and determine a plurality of input values 434 which optimize a first difference between the plurality of target controlled output values 432 and a plurality of estimated controlled output values according to the state of the control model 430, wherein the plurality of estimated controlled output values according to the state of the control model 430 are determined from the control model 420 using the plurality of plurality of controlled output values 428.

Updating the state of the control model 430 is a multi-step process, which is described in more detail below, and comprises the prediction of a future state according to a previous state. This results in predicted controlled output values for the next (predicted) state of the CFMF device 402. Updating the state of the control model 430 may also comprise a correction of a past state of the control model. For example, the estimated controlled output values according to a past state of the control model can be compared to the plurality of controlled output values 428 corresponding to the past state. The state of the control model 430 can subsequently be adjusted based on and the plurality of controlled output values 428 obtained from CFMF device 402.

The target controlled output values 432 are controlled output values that would correspond to an optimal condition of the CFMF system. For example, the optimal condition is the condition resulting from an optimized profit function, which would result in the most efficient condition of the CFMF system depending on various constraints. Such constraints are tailored to the CFMF device 402, representing limitations to the CFMF device and process, such as the maximum water flow into the CFMF device 402, the maximum permeate flow through the associated membranes, and safe operating limits for components of the CFMF device 402. For example, constraints may include a minimum and maximum concentration factor, a minimum and maximum water flow, a minimum and maximum target component concentration such as protein, and a minimum and maximum total solids concentration. The plurality of input values 434 are subsequently the values to be input to the CFMF device 402 from optimizing system 400 that would result in an adjustment of the CFMF device 402 process towards this optimal state. Therefore, the plurality of input values 434 are the input values to the CFMF device 402 that help minimize the difference between the controlled output values of the optimal state and the (predicted) controlled output values for the next state of the CFMF device 402. In other words, the plurality of input values 434 are the input values that help minimize the difference between the plurality of target controlled output values 432 and a plurality of estimated controlled output values according to the state of the control model 430.

An output interface 412 communicatively coupled to the CFMF device 402 and configured to cause the plurality of input values 434 to be output to the CFMF device 402 thereby decreasing a second difference between the plurality of target controlled output values 432 and a future plurality of controlled output values. The plurality of input values 434 may comprise a concentration factor comprising a first ratio of feed flow to outlet retentate flow and a water factor comprising a second ratio of water flow to feed flow. Subsequently, the output interface 412 is configured to cause the concentration factor and/or cause a water factor to be output the CFMF device 402.

The interface unit 404 comprises the input interface 408 and the output interface 412. The input interface 408 is communicatively coupled to the CFMF device 402 with connection 410, and the output interface 412 is communicatively couple to the CFMF device 402 with connection 414. For example, interface unit 404 may be communicatively coupled to the CFMF device 402 by a wired connection, an ethernet connection, or a wireless network connection.

Optimizing system 400 may continue or otherwise repeat the optimizing process of optimizing a difference between the target controlled output values 432 and estimated controlled output values according to a state of the control model 430, wherein the target controlled output values 432 and estimated controlled output values according to a state of the control model 430 are based on at least the plurality of controlled output values 428, and wherein controlled output values 418 may be future controlled output values.

Optimizing system 400 may perform an iterative process that is repeated at a fixed interval, such as 20 or 30 seconds, until a condition is met, for example an exit condition associated with an optimal target or a shut-down of the optimizing system 400 or CFMF device 402. For example, optimizing system 400 iteratively determines a new set of optimal input values at a fixed rate until the system 400 is terminated by an exit-command which could be the UF unit that stops production. Additionally, the control unit 406 may iteratively determine optimal values, which may be terminated at a certain optimality criteria.

In an iterative process, future controlled output values are obtained by optimizing system 400 using connection 410. For example, future controlled output values may become controlled output values 418. An iterative process allows for continual optimization adjustments as variables in the CFMF device 402 change over time, as shown in FIG. 3, and may result in a continual decrease in difference between the target controlled output values 432 and future controlled output values, even with fluctuations and variability in the plurality of controlled outputs 428 and plurality of disturbance values 426. These fluctuations can include changes to the concentration of feed stock components, membrane permeability, and the flow rate.

The control model 420 is configured to obtain plurality of disturbance values 426 and plurality of controlled output values 428 from the input interface 408, and further configured to estimate controlled output values according to a state of the control model 430, as previously disclosed. Control model 420 may be a physics-based, statistical-based, machine learning-based or other artificial intelligence (AI) based model. In this example, the control model 420 comprises a state-space model, wherein the state-space model is a discrete time model. For example, the control model 420 is a linear control model and the state of the control model 420 is updated using a time-varying Kalman filter. Alternatively, control model 420 could be any other suitable model.

As the control model 420 of this example is a state-space model, which is a discrete time model, subtext k, k−1, and k+1 is used to represent the current state, the previous state, and the next concurrent state respectively. Additionally, augmented variables use a bar notation, such as variables produced by control model 420 and optimizer 422. For example, \tilde{x}ₖ is the augmented current state vector of the corresponding current state vector xₖ. Estimated variables use a bar hat notation, such as \tilde{\hat{x}}ₖ as the estimated current state vector.

In order to obtain estimated controlled output values according to a state of the control model 430, wherein the state is a future state, the control model 420 is updated based on the current state of the control model. When using a linear control model, the updated state is a linearly adjusted current state (in combination with other linearly adjusted variables obtained by the control model 420). A linear adjustment to the current state is achieved by multiplying the current state (\tilde{x}ₖ) by a predetermined variable, Ā. Ā is a state-space matrix specific to the CFMF device 402, containing constants to account for the adjustment to state parameters during the discrete time interval between the current state \tilde{x}ₖ and the next state \tilde{x}ₖ₊₁. For example, the plurality of controlled outputs 428 change over time, and therefore current controlled outputs are multiplied by Ā to help form predicted future controlled outputs. Āx̅ₓ can therefore be considered the linearly adjusted current state, and a prediction of the next state. However, to improve upon this prediction, the impact of other variables is taken into account, including: inputs to the CFMF device 402 (uₖ), e.g. plurality of input values 434; the disturbance values (dₖ), e.g. plurality of disturbance values 426; and and noise values (w̅ₖ). Augmented noise values may account for any disturbances to the CFMF process that are not comprised within the plurality of disturbance values 426, such as variations to the process that cannot be accurately measured. Each of these variables are linearly adjusted using a separate state-space matrix tailored to the variable and the CFMF device 402. Additionally, a constant related to the linearization of the control model 420 is included (σ̅ₓ), comprising several constants related to the linearization of the nonlinear system equations. Together, these variables help compensate for a linearization of a non-linear system, resulting in an improved prediction accuracy. Tailoring the state-space matrices and determining the linearization constant can be achieved through standard approaches such as mathematical approximation, parameter tuning experimentation, and trial-and-error.

One example control model 420 is therefore

$${\overline{x}}_{k + 1} = \overline{A} {\overline{x}}_{k} + \overline{B} {u}_{k} + \overline{E} {d}_{k} + \overline{G} {\overline{w}}_{k} + {\overline{σ}}_{x}$$

$${y}_{k} = {\overline{C}}_{y} {\overline{x}}_{k} + {σ}_{y} + {v}_{k}$$

$${z}_{k} = {\overline{C}}_{z} {\overline{x}}_{k} + {σ}_{z}$$

where: \tilde{x}ₖ₊₁=[x;x_{d}]ₖ∈ [symbol] ⁿ^{ₓ} is the augmented state vector for the next (k+1) state of the control model, e.g. comprising the estimated controlled output values according to a state of the control model 430, wherein the current (k) state is \tilde{x}ₖ; uₖ∈ [symbol] ⁿ^{ᵤ} is the input, e.g. plurality of input values 434; dₖ∈ [symbol] ⁿ^{_{d}} is the measured disturbance values, e.g. plurality of disturbance values 426; yₖ∈ [symbol] ⁿ^{_{y}} is the measurement vector, e.g. plurality of controlled output values 428; zₖ∈ [symbol] ⁿ^{_{z}} is the controlled outputs of the current state xx; the augmented noise is w̅ₖ~N_{iid}(0,R̅_{w}); the measurement noise is vₖ~N_{iid}(0,Rᵥ); and G̅=I is the noise to state matrix. The noise variance matrices, R̅_{w} and Rᵥ, are estimated using the Maximum Likelihood (ML) method, or any other suitable approach.

The augmented state-space matrices are

$$\overline{A} = [ \begin{matrix}A & {B}_{d} \\ 0 & I\end{matrix} ] , \overline{B} = [ \begin{matrix}B \\ 0\end{matrix} ] , \overline{E} = [ \begin{matrix}E \\ 0\end{matrix} ] , {\overline{C}}_{y} = [ \begin{matrix}{C}_{y} & {C}_{d}\end{matrix} ] , {\overline{C}}_{z} = [ \begin{matrix}{C}_{z} & {C}_{d}\end{matrix} ]$$

where A, B, and E are variables associated with CFMF device 402. σ̅ₓ, σ_{y} and σ_{z} contain the constants related to a linearization of the control model 420. For example σ̅ₓ=x̅ₛₛ−Āx̅ₛₛ−B̅uₛₛ−Ēdₛₛ, σ_{y}=yₛₛ−C̅_{y}x̅ₛₛ, and σ_{z}=z̅ₛₛ−Č_{z}z̅ₛₛ, where the augmented state vector is x̅ₛₛ=[xₛₛ; 0]. Here, σ_{z} and C_{z} are formed by row selection of C_{y} and σ_{y}.

For the above process, a current state of the model (\tilde{x}ₖ) is required. The control model 420 may be further configured to estimate the state of the model (\overline{\hat{x}}ₓ) based on the plurality of the plurality of controlled output values 428 (yₖ). A linear time variant (LTV) Kalman filter can be used to estimate the state of the model (\overline{\hat{x}}ₖ). Beneficially, a time variance of the Kalman filter enables the control model 420 to handle variations in the size of yₖ due to any missing measurements. This scenario is described in more detail below.

For example, after the control model 420 has estimated controlled output values (ŷ_{k|k-1}) according to the state of the control model 430 (\overline{\hat{x}}_{k|k-1}) using a previous state (k−1), as previously described. The optimizer 422 is then configured to update the state of the control model based on the plurality of controlled output values 428 (yₖ). This involves computing a filtered state, where the plurality of controlled output values 428 (yₖ) are used to improve the state of the control model 430 (\overline{\hat{x}}_{k|k-1}), resulting in an updated (improved) current state (\overline{\hat{x}}_{k|k}). Combining this updated state (\overline{\hat{x}}_{k|k}) with plurality of input values 434 (uₖ), which represent optimal input values, the control model 420 can predict a new state \overline{\hat{x}}_{k+1|k} using the method previously described.

Part of computing the filtered state may include using the state covariance matrix of the augmented system (P̅), wherein covariance is a measure of the joint variability of state variables and evaluates to what extent the variables of the segmented system change together. The noise covariance matrices, (R̅_{w}, R̅ᵥ), are estimated from the covariances of noise relating to the CFMF device 402, and Rₑ is computed by Kalman filter iterations. The state covariance of the augment system improves the accuracy of computing the updated current state.

The on-line computations of control unit 406 in accordance with the above disclosure are as follows:

```
Require: yₖ, dₖ, [symbol] _{k|k-1}, P̅_{k|k-1}, uₖ₋₁
Filter: Compute the one-step ahead measurement prediction
            ŷ_{k|k-1} = C̅_{y,k}\hat{x̅} [symbol] _{k|k-1} + σ_{y,k},
            Compute the filtered state
            ${R}_{e , k} = {\overline{C}}_{y , k} {\overline{P}}_{k \vert k - 1} {\overline{C}}_{y , k}^{T} + {R}_{v , k}$
            ${\overline{K}}_{fx , k} = {\overline{P}}_{k \vert k - 1} {\overline{C}}_{y , k}^{T} + {R}_{e , k}^{- 1}$ [symbol]
            _{k|k} = [symbol] _{k|k-1} + K̅_{fx,k}(yₖ − ŷ_{k|k-1})
            ${\overline{P}}_{k \vert k} = {\overline{P}}_{k \vert k - 1} - {\overline{K}}_{fx , k} {R}_{e , k} {\overline{K}}_{fx , k}^{T}$
Obtain (1): rₖ = ρ ( [symbol] _{k|k} dₖ, k)
Obtain (2): uₖ = μ(rₖ, [symbol] _{k|k}, uₖ₋₁, dₖ)
Predictor: Compute the one-step ahead state, [symbol] _{k+1|k}, using [symbol]
            _{k+1|k} = Ā [symbol] _{k|k} + B̅uₖ + Ēdₖ + σ̅ₓ
            P̅_{k+1|k} = ĀP̅_{k|k}Ā^{T} + G̅R̅_{w}G̅^{T}
Return: uₖ, [symbol] _{k+1|k}, P̅_{k+1|k}
```

The filter steps correct the estimated current state according to the past state \overline{\hat{x}}_{k|k-1} using the latest measurements yₖ. The filter steps also enable handling of missing observations by constructing the measurement related properties, providing ŷ_{k|k-1}. Together, this results in a corrected current state \overline{\hat{x}}_{k|k}. The predictor steps may use the control model 420 to predict x̅ₖ₊₁, and the predictor steps use the corrected current state, \overline{\hat{x}}_{k|k}, along with the obtained target values rₖ and optimal inputs uₖ, to predict a future state \overline{\hat{x}}_{k+1|k}. Example steps to obtain (1), the target controlled output values 432, rₖ, and example steps to obtain (2), the plurality of input values 434, uₖ, are detailed below.

The MPC layer 424 is configured to obtain (1), a plurality of target controlled output values 432 (rₖ), and determine (2) a plurality of input values 434 (uₖ), which help optimize the future CFMF process, as previously described. The plurality of input values 434 (uₖ) optimize a difference between the plurality of target controlled output values 432 (rₖ) and a plurality of controlled output values associated with the estimated updated state \overline{\hat{x}}_{k|k}. This can be achieved using standard mathematical or computation approaches, including absolute difference, mean squared difference, or a more complex approach such as a formula that minimises the difference while also including the impact of constraints. The skilled person will appreciate that the selection of the type of equation used may depend on factors regarding the usage of the system.

Constraints are system and process limitations associated with CFMF system 402, such as those previously described. Constraints relating to the minimum and maximum safe operating range of input values to the CFMF device 402, for example minimum and maximum concentration factors and water factor constraints can be represented as uₘᵢₙ and uₘₐₓ. Constraints relating to time can also be incorporated, such as by constraining the system to a particular state, such as \overline{\hat{x}}_{k|k}. There may also be constraints relating to control model 420, and the limitations associated with the chosen configuration. For example, a linear control model would have limitations relating to the linearization of a non-linear system, wherein input values outside the limits would result in predictions below an accepted accuracy. Therefore, the complex formula may be formed such that the difference between the plurality of target controlled output values 432 (rₖ) and a plurality of controlled output values associated with the estimated updated state \overline{\hat{x}}_{k|k} is minimized, but any potential input values ūₖ that broke constraints would be penalized.

For example, to determine (2), the MPC layer 424 can be formed as an output tracking problem in the form of a convex quadratic problem (QP).

$${min}_{{\{ {u}_{k + j} \}}_{j = 0}^{N - 1}} ∅ = \frac{1}{2} {\sum }_{j = 1}^{N} {‖ {z}_{k + j} + {r}_{k} ‖}_{2 , {Q}_{z}}^{2} + \frac{1}{2} {\sum }_{j = 0}^{N - 1} {‖ Δ {u}_{k + j} ‖}_{2 , {S}_{u}}^{2}$$

with constraints

$${\overline{x}}_{k} = {\hat{\overline{x}}}_{k \vert k} , \qquad ( a )$$

$${\overline{x}}_{k + j + 1} = \overline{A} {\overline{x}}_{k + j} + \overline{B} {u}_{k + j} + \overline{E} {d}_{k} + {\overline{σ}}_{x} , j ∈ {N}_{u} , \qquad ( b )$$

$${z}_{k + j} = {\overline{C}}_{z} {\overline{x}}_{k + j} + {σ}_{z} , j ∈ {N}_{z} , \qquad ( c )$$

$${u}_{min} \leq {u}_{k + j} \leq {u}_{max} , j ∈ {N}_{u} , \qquad ( d )$$

in which Δuₖ₊ⱼ=uₖ₊ⱼ₋₁uₖ₊ⱼ₋₁ and N_{z}={1, 2, . . . , N}, Nᵤ={0, 1, . . . , N−1}. N can be the control horizon and/or prediction horizon, with j being the iteration number. Here, the control and prediction horizon are different from each other, shown by N_{z} and Nᵤ. The estimated current state, \overline{\hat{x}}_{k|k}, is assigned to the initial state by constraint (a). Constraint (b) and constraint (c) are the augmented state-space constraints, for example (Ā, B̅, Ē, C̅_{z}), and the offset constants σ̅ₓ and σ_{z}, related to the linearization of the control model 420. Constraint (d) expresses the input limits, also known as the input constraints, guaranteeing a safe operating zone for the CFMF device 402. As there are no forecasts available for the target, rₖ, and the measured disturbance values, dₖ, the same-as-now predictions are used, as it is unknown how rₖ or dₖ will vary across the control and prediction horizon. Output constraints on zₖ₊ⱼ are also possible with slack-variables (not shown here for simplicity).

In some embodiments, the QP is solved using existing methods such as active-set methods, interior-point methods, and first-order gradient methods. For example, a primal-dual interior-point QP solver may be used based on a tailored Mehrotra's predictor-corrector algorithm. Preferably, warm starting is used to speed up the solution time. For example, re-using previous solutions or early termination can be used. The solution can subsequently be defined by the function

$${u}_{k} = μ ( {r}_{k} , {\hat{\overline{x}}}_{k \vert k} , {u}_{k - 1} , {d}_{k} )$$

which defines an on-line computation of MPC layer 424.

Beneficially, the use of a QP with multiple constraints as described above results in optimal input values, uₖ, that can be safely output to the CFMF device 402 without manual or automated intervention, as limitations associated with safe operating procedures and the operating limits of the CFMF components are incorporated into the QP.

Preferably, the optimizer 422 further comprises a real-time optimization (RTO) layer 436, wherein RTO layer 436 is configured to determine (1), the plurality of target controlled output values 432 (rₖ), which is obtained by the MPC layer 424 described above. Alternatively, control model 420 may obtain (1) from alternative sources or methods, for example from input interface 408.

RTO layer 436 is configured to determine optimal future input values 434 based on a future efficiency of the CFMF device 402, and further determine the target controlled output values 432 based on the optimal future input values 434. For example, RTO layer 436 may be configured to determine optimal future input values 434 and/or optimal output values which optimize an objective function, wherein the objective function estimates a future efficiency of the filtration process of the CFMF device 402 according to one or more constraints, such as those previously disclosed. The one or more constraints used to optimize the objective function may comprise one or more of a minimum concentration of the target component in the outlet retentate flow, a maximum concentration of the target component in the outlet retentate flow, and one or more input value limits associated with the CFMF device 402.

Control unit 406 may be further configured to obtain constraints related to CFMF device 402 used to optimize the first cost function. One example of a cost function and the associated constraints is disclosed below. In another example, constraints may be obtained from interface unit 404, and constraints may comprise operational constrains of the CFMF device 402, including constraints related to any of the following: water flow rate associated with CFMF device 402; controlled output variables associated with CFMF device 402; controlled input variables associated with CFMF device 402; and manipulated variable constraints associated with CFMF device 402, wherein manipulated variables are based on controlled output variables or controlled input variables associated with CFMF device 402 that have been processed within control unit 406.

The plurality of optimal future input values 434 which optimize the objective function can be determined using an interior-point algorithm for a non-linear problem. Alternatively, a linear problem can be used to determine the target, optimal, future input value 434. Additionally, the plurality of input values 434 and/or output values which optimize the difference between the plurality of target controlled output values 432 and the plurality of estimated controlled output values can be determined using a quadratic program solver. In one example, the quadratic program solver is one of an active set method, an interior-point method, and a first-order gradient method, or any other suitable method.

For example, the objective function (p) may be formed such that it includes the controlled outputs (zₛₛ) for an optimal steady-state (x̅ₛₛ), inputs for an optimal steady-state (uₛₛ), and the disturbances affecting the current state (dₖ). The constraints may be formed into a penalty function, which would prevent optimization of the objective function if constraints were broken. Therefore, the optimization problem may comprise both the objective function (p) and a penalty function. The plurality of target controlled output values 432 (rₖ) may then be determined from the resulting controlled outputs zₛₛ of the solved optimization problem.

Preferably, the RTO layer 436 disclosed above solves the optimization problem

$${min}_{{u}_{s s} , {z}_{ss} , s} {∅}_{s s} = - p ( {z}_{ss} , {u}_{ss} , {d}_{k} ) + {‖ s ‖}_{2 , {S}_{w}}^{2}$$

with the constraints

$$[ \begin{matrix}0 & I\end{matrix} ] {\overline{x}}_{s s} = [ \begin{matrix}0 & I\end{matrix} ] {\hat{\overline{x}}}_{k \vert k} , \qquad ( e )$$

$${\overline{x}}_{s s} = \overline{A} {\overline{x}}_{s s} + \overline{B} {u}_{s s} + \overline{E} {d}_{k} + {\overline{σ}}_{x} , \qquad ( f )$$

$${z}_{s s} = {\overline{C}}_{z} {\overline{x}}_{s s} + {σ}_{z} , \qquad ( g )$$

$${u}_{min} + {δ}_{u} \leq {u}_{s s} \leq {u}_{max} - {δ}_{u} , \qquad ( h )$$

$${z}_{min} - s + {δ}_{z} \leq {z}_{s s} \leq {z}_{max} + s - {δ}_{z} , and \qquad ( i )$$

$$s \geq 0. \qquad ( j )$$

The problem function, Øₛₛ, is the sum of the objective function, p(zₛₛ, uₛₛ, dₖ), and a penalty function

$${‖ s ‖}_{2 , {S}_{w}}^{2}$$

that penalizes violations of the output constraints. The target is set to the optimal controlled output value, rₖ=zₛₛ, when the above problem is solved. The integrating disturbance states, x_{d,k}=[0 I]\overline{\hat{x}}_{k|k}, are fixed to their current values by constraint (e), for simplicity. The control model 420 is used in the constraints (f) and (g) to determine the steady-state relation between the inputs, uₛₛ, and the controlled outputs, zₛₛ. uₘᵢₙ and uₘₐₓ define the system and process input constraints as previously described. zₘᵢₙ and zₘₐₓ define the system and process output constraints. δᵤ and δ_{z} contains a back-off in the manipulated and controlled variables to maintain controllability in the MPC layer 424. s_{w} is a preselected variable sufficiently large to avoid violation of the constraints in general, with S_{w}=diag(s_{w}). Preferably, s_{w} is tailored specifically to the CFMF device 402. The nonlinear profit function p may also be tailored to the CFMF device 402. The input and output constraints together provide a region in which safe operation is guaranteed.

Existing software functions can be used to solve the optimization problem, depending on the formation of the optimization problem. For example, the sequential quadratic programming (SQP) method may be used to solve the above problem function, wherein the SQP method is a quasi-Newton implementation with line search for step-size selection. The solution can be defined by the function

$${r}_{k} = ρ ( {\hat{\overline{x}}}_{k \vert k} , {d}_{k} , k )$$

in which \overline{\hat{x}}_{k|k} is the current state estimate where only the offset states are utilized for model corrections and dₖ is the plurality of disturbances 426 for the current state k. The determined target controlled output values 432 (rₖ) can subsequently be obtained by MPC layer 424 for determining a plurality of input values 434 (uₛₛ), as described above.

A set of example on-line computations of RTO layer 436 are disclosed below. The on-line computations of RTO layer 436 require three inputs, including: \overline{\hat{x}}_{k|k}, the corrected current state, which can be obtained from control model 420 and comprises the estimated controlled output values according to a state of the control model 430; dₖ, the plurality of disturbance values 426, which can be obtained from input interface 408 or otherwise from the CFMF device 402; and k, the number of the current state iteration. The optimal solution state x*, consists of optimal inputs, uₛₛ, and optimal controlled outputs, zₛₛ, which optimize a cost function q.

Solving the NLP problem, problem (xᵢₙᵢₜ, dₖ, \overline{\hat{x}}_{k|k}), which may be the problem function described above, requires computing the cost function q and computing the associated constraints c_{eq} and c_{ineq}, Where xᵢₙᵢₜ is the initial state. c_{eq} represents the difference between the controlled outputs of the cost function and the optimal controlled outputs zₛₛ, while c_{ineq} represents the system and process constraints previously described. The cost function q estimates a future efficiency of the filtration process according to the function constraints S_{w}, s^{T}, and s_{w}. As described above, the function constraints are predetermined and may be tailored to the CFMF device 402 and with s^{T} introduced to account for any additional variations introduced in the on-line computational approach. Together, the constraints provide a region in which safe operation is guaranteed and account for potential limitations introduced from components of the CFMF device 402 and mathematical and/or computational approaches taken in optimizing system 400. Existing software solvers such as, solve, are then used to determine the controlled outputs zₛₛ of the solution state, resulting in the target controlled output values 432 rₖ.

| | |
|---|---|
| Require: | [symbol] _{k\|k}, dₖ, k |
| Solve NLP: | x* = solve(problem(xᵢₙᵢₜ, dₖ, [symbol] _{k\|k})) |
| | [uₛₛ, zₛₛ, s] = unpack(x*) |
| | rₖ = zₛₛ |
| | Return rₖ |
| Require: | [q, c_{eq}, c_{ineq}] = problem(x, dₖ, [symbol] _{k\|k}) |
| | [u, z, s] = unpack(x*) |
| | Compute the cost function |
| | $q = - p ( z , u , {d}_{k} ) + \frac{1}{2} {s}^{T} {S}_{W} + {s}^{T} {s}_{w}$ |
| | Compute the equality constraints |
| | x_{d,k} = [0 I ] [symbol] _{k\|k} |
| | x̅ₛₛ = (I − A)⁻¹ (Bu + Edₖ + B_{d}x_{d,k} + σₓ) |
| | zₛₛ = C_{y}xₛₛ + C_{d}x_{d,k} + σ_{z} |
| | c_{eq} = z − zₛₛ |
| | Compute the inequality constraints |
| | c_{ineq} = [s ≥ 0; uₘᵢₙ + δᵤ ≤ u ≤ uₘₐₓ − δᵤ; zₘᵢₙ − s + δ_{z} ≤ |
| | zₛₛ ≤ zₘₐₓ + s − δ_{z}] |

Control unit 406 may be further configured for use as a soft-sensor. A soft-sensor is a virtual sensor, where output data comprises measurements predicted from mathematical or computational methods, as opposed to being measured using hardware sensors and actuators. Typically, a soft-sensor use input data to determine a predicted measurement, obtaining an indirect measurement of the target variable. In a situation where one or more of the controlled output values of the plurality of controlled output values 428 are unknown, additional assumptions in control unit 406 can be made. Using a physics-based (or alternatively any statistical-based, machine learning-based or other AI-based) model, unknown values can be estimated. Examples of soft-sensors used in the present invention are explained in detail below.

While the plurality of controlled output values 428, yₖ, are obtained from one or more sensors of the CFMF device 402 (e.g. sensor 240 of FIG. 2), at least one of the plurality of controlled output values 428 may be obtained from a soft-sensor, such as when there are variations in the size of yₖ due to any missing measurements. For example, optimizer 422 may require a current value of the target component content, such as protein, and the total solids in the final concentrate stream. In the situation where these sensor values are not available, optimizer 422 may predict these missing values by using the soft-sensor.

In one example, the soft-sensor may comprise control model 420, such that the plurality of controlled output values 428 are estimated by the control model 420. As previously disclosed, control model 420 enables handling of missing observations by constructing the measurement related properties (providing ŷ_{k|k-1}). Beneficially, this results in control unit 406 remaining operational when the number of controlled output values within the plurality of controlled output values 428 varies. For example, the plurality of controlled output values 428 may vary in number of controlled output values when particular variables associated with the CFMF device 402 are lacking for a particular sample at a corresponding time point. Specifically, a controlled output value from the plurality of controlled output values 428 for a current state may not be available due to a mechanical failure of a sensor. This lack of previously available data results in a variation in the size of a vector for the plurality of controlled output values 428.

In another example, soft-sensor computation for obtaining a plurality of controlled output values 428 can comprise computing an inlet composition of each of the plurality of membrane stacks. One example of soft-sensor computation uses mass-balance, also known as a mass balance approach, which applies conservation of mass to the analysis of the filtration process. By accounting for material entering and leaving a system, otherwise unknown mass flows, such as the feed stock and water flow, can be identified. Difficult to measure and/or otherwise unquantifiable measurements can be determined by applying known measurements to the mass-balance technique and solving conservation equations, mass-balance equation, for the known measurements.

One example application of the mass-balance technique according to an aspect of the present disclosure is as follows. A feed stock (e.g. input feed stock 212 of FIG. 2) with unknown feed flow F_{f} and unknown feed composition x_{f} enters stack X (e.g. membrane stack 230 of FIG. 2), wherein there are N stacks in total. A permeate flow (e.g. permeate flow 238) leaves the stack X with permeate flow Fₚ and unknown permeate composition xₚ. x_{f} and xₚ may comprise of multiple parameters, for example protein, lactose, fat, and ash.

Other variables include the input water flow F_{w} and water composition x_{w} (e.g. input water flow 214 of FIG. 2), and the retentate flow (e.g. outlet retentate flow 218 of FIG. 2) leaves stack X with retentate flow Fᵣ and retentate composition xᵣ.

The transfer of components through a filter of stack X can be written as the function Jₛ(xᵣ, Fₚ, xₚ).

The resulting mass-balance equations are

$${F}_{r} = {F}_{w} + {F}_{f} - {F}_{p}$$

$${F}_{r} * {x}_{r} = {F}_{w} * {x}_{w} + {F}_{f} * {x}_{f} - {F}_{p} * {x}_{p}$$

$$0 = {F}_{p} * {x}_{p} - A * {J}_{s} ( {x}_{r} , {F}_{p} , {x}_{p} )$$

where A is the membrane area of 230 specific to the CFMF device 402, and Jₛ(xᵣ, Fₚ, xₚ) is a function for the solute flux, dependent on the selection of membranes and osmotic resistance of the components and specific to the CFMF device 402. These values can be obtained mathematically and from a parameter fitting task. For example, the solute flux Jₛ(xᵣ, Fₚ, xₚ) can be calculated using the solute concentration, c̅ₛ, the solute permeability, ω, and the reflection coefficient σᵣ. σᵣ is a measure of the selectivity of a membrane and typically has a value between 0 and 1, wherein:
σᵣ=1 represents an ideal membrane with no solute transport
σᵣ<1 represents a non-ideal membrane, which is not a completely semipermeable membrane, and solute transport, and
σᵣ=0 represents a membrane with no selectivity.

The solute flux Jₛ function can be written as

$${J}_{s} ( {x}_{r} , {F}_{p} , {x}_{p} ) = {\overline{c}}_{s} ( 1 - {σ}_{r} ) {J}_{v} + ωΔπ$$

where Jᵥ is the volume flux, written as Jᵥ=Lₚ(ΔP−σᵣΔπ). Lₚ is the solvent (water) permeability, ΔP is the hydrodynamic pressure difference/applied pressure across the membrane, and Δπ is the osmotic pressure difference across the membrane. Lₚ can be obtained using experiments with pure water, where Δπ=0, due to the resulting linear relationship between Jᵥ and ΔP. Both coefficients ω and σᵣ can be obtained experimentally by performing an osmotic and diffusion experiment, such as using CFMF system 400 and taking additional laboratory measurements to subsequently solve the set of mass-balance-equations with respect to the coefficients ω and σᵣ.

Solving the three mass-balance equations for the unknown variables F_{f}, x_{f} and xₚ makes it possible to estimate, or otherwise determine, the necessary variables for obtaining a plurality of controlled output values 428.

This soft-sensor computation approach can be repeated for each of the membranes within the plurality of membrane stacks, and can be repeated for each stack, for example N times.

The above disclosed filtration process of CFMF device 402 may be one of a cross flow UF process, a MF process, or a NF process. For example, the filtration process may be a cross flow UF process, wherein the flow of feed stock comprises a dairy feed stock and the target component in the feed stock of the outlet retentate flow is protein. The water associated with CFMF device 402 may be a deionised water, or water extracted from another CFMF process. Other example target components may include: whey protein concentrate, whey protein isolate, milk protein concentrate, milk protein isolate, micellar casein concentrate, micellar casein isolate, and lactoferrin.

Optionally, the optimizing system 400 further comprises at least one programmable logic controller (PLC) and an edge-computing device communicatively coupled to the at least one PLC and comprising one or more processors and a memory. In one example, the PLC comprises the input interface 408 and the output interface 412 and the edge-computing device comprises the control model 420 and the optimizer 422.

Optimizing system 400 can be used during optimizing CFMF process period 306 of FIG. 3. For example, the CFMF device 402 may be CFMF system 200.

One aspect of the present disclosure relates to the water optimizing system of FIG. 5.

FIG. 5 shows a water optimizing system 500 and a CFMF device 502. The water optimizing system 500 comprises an interface unit 504 and a control unit 506. The interface unit 504 further comprises an output interface 508, and connection 510. Control unit 506 further comprises a membrane control model 512, estimated concentration values 514, an optimization unit 516, input membrane water flow values 518, and optimal input flow of water 520.

FIG. 5 shows a water optimizing system 500 for optimizing water consumption at a CFMF device 502 comprising a plurality of membranes each of which performing a filtration process which separates a flow of feed and a flow of water into a retentate flow and an permeate flow. The water optimizing system 500 comprises a membrane control model 512 associated with the plurality of membranes. The membrane control model 512 is configured to estimate a concentration value 514 based on input membrane water flow values 518, corresponding to an input flow of water to each of the plurality of membranes, wherein the concentration value is associated with an estimated concentration of solid components in the retentate flow.

The water optimizing system 500 further comprises an optimization unit 516 configured to obtain an optimal concentration value associated with solid components in the retentate flow and determine an optimal input flow of water 520 for each of the plurality of membranes, such as each membrane stack, which minimizes a difference between the optimal concentration value and an estimated concentration value 514, wherein the estimated concentration value is determined from the membrane control model 512 based on the optimal input flow of water 520 for each of the plurality of membranes.

The water optimizing system 500 further comprises an output interface 508 communicatively coupled to the CFMF device 502 using connection 510 and configured to cause the CFMF device 502 to adjust the flow of water at each of the plurality of membranes of the CFMF device 502 according to the optimal input flow of water 520 determined for each of the plurality of membranes. This may result in a decrease in difference between the optimal concentration values and future concentration values. Optionally, future water flow values are obtained by water optimizing system 500 using connection 524 and/or input membrane water flow values 518. For example, future water flow values may become input membrane water flow values 518. The water optimizing system 500 may further comprise an input interface 522 and connection 524. For example, input interface 522 may be communicatively coupled to the CFMF device 502 with connection 524, such as via a wired connection, an ethernet connection, or a wireless network connection.

The membrane control model 512 comprises one of a physics-based model, a statistical model, or a machine learning model. For any of these approaches, membrane control model 512 may estimate concentration values 514 associated with solid components in an outlet retentate flow based on obtained controlled output values (e.g. plurality of controlled output values 428 of FIG. 4).

In one example, the membrane control model 512 is further configured to estimate the concentration value 514 based on a plurality of filter specifications associated with the plurality of membranes, wherein each of the plurality of filter specifications comprises a water permeability of an associated membrane, Lₚ, solute concentration of the associated membrane, c̅ₛ, the solute permeability of the associated membrane, ω, the reflection coefficient of the associated membrane, σᵣ, and a membrane area of the associated membrane which can be used to calculate pressure (e.g. hydrodynamic pressure difference ΔP and/or osmotic pressure difference Δπ).

For example, membrane control model 512 may use the previously disclosed mass-balance equations as used in soft-sensor computation. Specifically, optimization unit 516 and/or membrane control model 512 may use the previously disclosed mass-balance equation

$${F}_{r} * {x}_{r} = {F}_{w} * {x}_{w} + {F}_{f} * {x}_{f} - {F}_{p} * {x}_{p}$$

with the aim of minimizing F_{w} to meet concentration criteria, wherein the concentration criteria is set by minimizing a difference between the optimal concentration value and an estimated concentration value 514 and/or maximizing the total concentration (total solids) in the retentate flow, without breaking predetermined constraints. The optimization process is configured to distribute the water flow to the membrane stack such that water is best utilised.

The mass-balance equations can be used to form an objective function which is to be minimized, for example a nonlinear function, which originates from the mass-balance comprising the sum of all water flows, or a linear function, such as a linearized version of the nonlinear equation. The objective function can then be used to optimize the CFMF process. The objective function is subject to upper constraints equal to the total solids and target component content, and equality constraints for the final stage equal to the total solids and target component content. This results in the optimal water flow split for each stack, while still satisfying the quality specifications of the product. Alternatives to this method may include direct search methods or extremum seeking methods, which use values of the objective function only to search or control the concentration of target components/total solids in each stack. Alternatively, the solution may be searched for by applying automated trial-and-error methods and a search for an optimal split.

In more detail, the mass-balance technique according to an aspect of the present disclosure is as follows. A feed stock (e.g. input feed stock 212 of FIG. 2) with feed flow F_{f} and feed composition x_{f} enters stack X (e.g. membrane stack 230 of FIG. 2), wherein there are N stacks in total. A permeate flow (e.g. permeate flow 238) leaves the stack X with permeate flow Fₚ and permeate composition xₚ. x_{f} and xₚ may comprise of multiple parameters, for example protein, lactose, fat, and ash. Other variables include the input water flow F_{w} and water composition x_{w} (e.g. input water flow 214 of FIG. 2), and the retentate flow (e.g. outlet retentate flow 218 of FIG. 2) leaves stack X with retentate flow Fᵣ and retentate composition xᵣ. The transfer of components through a filter of stack X can be written as the function Jₛ(xᵣ, Fₚ, xₚ). The resulting mass-balance equations are as previously disclosed:

$${F}_{r} = {F}_{w} + {F}_{f} - {F}_{p}$$

$${F}_{r} * {x}_{r} = {F}_{w} * {x}_{w} + {F}_{f} * {x}_{f} - {F}_{p} * {x}_{p}$$

$$0 = {F}_{p} * {x}_{p} - A * {J}_{s} ( {x}_{r} , {F}_{p} , {x}_{p} )$$

where A is the membrane area specific to the CFMF device 402 (e.g. the membrane area of membrane stack 230 of FIG. 2) and Jₛ(xᵣ, Fₚ, xₚ) is a function for the solute flux, dependent on the selection of membranes and osmotic resistance of the components and specific to the CFMF device 402.

These values can be obtained mathematically and from a parameter fitting task. For example, the solute flux Jₛ(xᵣ, Fₚ, xₚ) can be calculated using the solute concentration, c̅ₛ, the solute permeability, ω, and the reflection coefficient σᵣ. σᵣ is a measure of the selectivity of a membrane and typically has a value between 0 and 1, wherein:
σᵣ=1 represents an ideal membrane with no solute transport.
σᵣ<1 represents a non-ideal membrane, which is not a completely semipermeable membrane, and solute transport, and
σᵣ=0 represents a membrane with no selectivity.

The solute flux Jₛ function can be written as

$${J}_{s} ( {x}_{r} , {F}_{p} , {x}_{p} ) = {\overline{c}}_{s} ( 1 - {σ}_{r} ) {J}_{v} + ωΔπ$$

where Jᵥ is the volume flux, written as Jᵥ=Lₚ (ΔP−σ,Δπ). Lₚ is the solvent (water) permeability, ΔP is the hydrodynamic pressure difference/applied pressure across the membrane, and Δπ is the osmotic pressure difference across the membrane. Lₚ can be obtained using experiments with pure water, where Δπ=0, due to the resulting linear relationship between Jᵥ and ΔP. Both coefficients ω and σᵣ can be obtained experimentally by performing an osmotic and diffusion experiment, such as using CFMF system 400 and taking additional laboratory measurements to subsequently solve the set of mass-balance-equations with respect to the coefficients ω and σᵣ.

Solving the three mass-balance equations makes it possible to estimate, or otherwise determine, the necessary variables for obtaining concentration values 514.

Optionally, water optimizing system 500 further comprises a real-time optimizer (RTO), wherein the target concentration value is obtained from the RTO. The target concentration value may be an optimal concentration value. For example, the RTO may be RTO layer 436 of FIG. 4. The RTO is configured to determine a plurality of optimal future input values which optimize a first cost function, wherein the first cost function estimates a future efficiency of the filtration process according to one or more constraints. The RTO is further configured to determine the target/optimal concentration value from a device control model associated with the CFMF device 502 based on the plurality of optimal future input values, wherein the membrane control model 512 estimates concentration values 514 from input values according to a state of the device control model and/or input membrane water flow values 518. Alternatively, the target/optimal concentration value may be predetermined or otherwise obtained, such as from an operator or algorithmically.

The one or more constraints used to optimize the first cost function may comprise one or more of a minimum concentration of a target component in the outlet retentate flow, a maximum concentration of the target component in the outlet retentate flow, and one or more input value limits associated with the CFMF device 502.

The optimal input flow of water 520 for each of the plurality of membranes may also be determined using a sequential quadratic programming optimization method, or determined using one of a direct search method, an extremum seeking method, or a trial-and-error method.

Water optimizing system 500 may perform an iterative process, which can be repeated until a condition is met. Water optimizing system 500 may continue or otherwise repeat the process of optimizing a difference between the target/optimal concentration value and estimated concentration value.

CFMF device 502 may be CFMF system 200 of FIG. 2 and/or CFMF device 402 of FIG. 4. The filtration process may be one of a cross flow UF process, a MF process, or a NF process.

In one example, the filtration process is a cross flow UF process, and the flow of feed stock comprises a dairy feed stock and the target component in the feed stock of the product flow is protein. Other example target components may include: whey protein concentrate, whey protein isolate, milk protein concentrate, milk protein isolate, micellar casein concentrate, micellar casein isolate, and lactoferrin. Water optimizing system 500 reduces the water consumption of the cross flow UF process, and the membrane control model 512 predicts the concentration of each component (lactose, minerals, protein and water) in all streams of the process using the previously disclosed soft-sensor methodology. Knowing the estimated concentration of the components and the membrane filter specifications, the optimal water flow into each stack of the membranes is estimated. This results in an increase in the total solids and proteins to the specified level from optimization unit 516, while not blocking the membranes and reducing the amount of water required in the process.

In another example, the water associated with CFMF device 502 is a deionised water.

Optionally, the water optimizing system 500 further comprises at least one PLC and an edge-computing device communicatively coupled to the at least one PLC and comprising one or more processors and a memory. For example, the PLC comprises the input interface 522 and the output interface 508, and/or the edge-computing device comprises the membrane control model 512 and the optimization unit 516.

One aspect of the present disclosure relates to the optimizing system of FIG. 6.

FIG. 6 shows a system 600 and a CFMF device 602 which is configured to optimize both the filtration process and water consumption. FIG. 6 further shows an input interface 604, controlled output values 606, disturbance values 608, device control model 610, estimated controlled output values according to a state of the device control model 612, plurality of controlled output values 614, and plurality of disturbance values 616. System 600 further comprises a membrane control model 618, estimated concentration value 620, input flow of water 622, and an optimizer 624. FIG. 6 also shows an MPC layer 626, target controlled output values 628, optimal input values 630, WFO layer 632, target/optimal concentration value 634, optimal input flow of water 636, output interface 638, measured values 640, and RTO layer 642. FIG. 6 further includes interface unit 644, connection 646, connection 648, and control unit 650.

System 600 optimizes a filtration process performed at a CFMF device 602 comprising a plurality of membranes, each of which performing a filtration process which separates a flow of feed stock and a flow of water into an outlet retentate flow and an outlet permeate flow. The plurality of membranes may form one or more membrane stacks. The system 600 comprises an input interface 604 communicatively coupled to the CFMF device 602 configured to obtain a plurality of controlled output values 606 associated with the filtration process performed at the CFMF device 602, wherein the plurality of controlled output values 606 comprise: (i) a product concentration value indicative of concentration of a target component of the feed stock in the outlet product flow, and (ii) a total concentration value indicative of concentration of components in the outlet product flow; and obtain a plurality of disturbance values 608 associated with the CFMF device 602. The product flow may comprise a permeate and/or retentate flow. For example, (i) may be a retentate concentration value indicative of concentration of protein in the outlet retentate flow, and (ii) may be a total concentration value indicative of concentration of all solid components in the outlet retentate flow. System 600 further comprises a device control model 610 associated with the CFMF device 602, wherein the device control model 610 estimates controlled output values according to a state of the device control model 612 from plurality of controlled output values 614 and plurality of disturbance values 616.

System 600 further comprises a membrane control model 618 associated the plurality of membranes, wherein the membrane control model 618 is configured to estimate a concentration value 620 based on an input flow of water 622 to each of the plurality of membranes, wherein the concentration value is associated with an estimated concentration of solid components in the outlet retentate flow.

System 600 further comprises an optimizer 624 comprising a model predictive control (MPC) layer 626 and a water flow optimization (WFO) layer 632, wherein the optimizer 624 is configured to update the state of the device control model 610 based on the plurality of controlled output values 614. The MPC layer 626 is configured to: obtain a plurality of target controlled output values 628; and determine a plurality of input values 630 which optimize a first difference between the plurality of target controlled output values 628 and a plurality of estimated controlled output values according to a state of the device control model 612, wherein the plurality of estimated controlled output values are determined from the device control model 610 using the plurality of plurality of controlled output values 614. The WFO layer 632 is configured to obtain an optimal concentration value 634 (or a target concentration value) associated with solid components in the outlet retentate flow; determine an optimal input flow of water 636 for each of the plurality of membranes which minimizes a difference between the target/optimal concentration value 634 and an estimated concentration value 620, wherein the estimated concentration value 620 is determined from the membrane control model 618 based on the input flow of water 622 for each of the plurality of membranes; and adjust the plurality of input values 630 determined by the MPC layer 626 based on the optimal input flow of water 636 for each of the plurality of membranes.

System 600 further comprises an output interface 638 communicatively coupled to the CFMF device 602 and configured to cause the plurality of input values 630 to be output to the CFMF device 602 thereby decreasing a second difference between the plurality of target controlled output values 628 and a future plurality of controlled output values.

Input interface 604 and output interface 638 may be components of an interface unit 644. Optionally, device control model 610, membrane control model 618, and optimizer 624 may be components of a control unit 650. Input interface 604 is communicatively coupled to CFMF device 602 by connection 646, and output interface 638 is communicatively coupled to CFMF device 602 by connection 648. For example, interface unit 644 may be communicatively coupled to the CFMF device 602 by a wired connection, an ethernet connection, or a wireless network connection. Optionally, output interface 638 may be output interface 412 of FIG. 4, and input interface 604 may be input interface 408 of FIG. 4.

The membrane control model 618 may be a physics-based (or alternatively any statistical-based, machine learning-based or other AI-based) model and may be further configured to estimate the concentration value 620 based on a plurality of filter specifications associated with the plurality of membranes. Optionally, each of the plurality of filter specifications comprises a water permeability of the first associated membrane, Lₚ, solute concentration of the first associated membrane, c̅ₛ, the solute permeability of the first associated membrane, ω, and the reflection coefficient of the first associated membrane, σᵣ, and a membrane area of the first associated membrane which can be used to calculate pressure. For example, membrane control model 618 may use the previously disclosed mass-balance equations. Optionally, membrane control model 618 may obtain measured values 640 from input interface 604. Measured values 640 may contain values associated with concentration and/or water flow, such as the known variables of the previously disclosed mass-balance equations.

Preferably, optimizer 624 further comprises a real-time optimization (RTO) layer 642 configured to determine the plurality of target controlled output values 628 obtained by the MPC layer 626. In one example, the RTO layer 642 is further configured to determine a plurality of optimal future input values which optimize a first cost function, wherein the first cost function estimates a future efficiency of the filtration process according to one or more constraints. RTO layer 642 further determines the plurality of target controlled output values 628 from the device control model 610 based on the plurality of optimal future input values.

The MPC layer 626 and RTO layer 642 may utilize the mathematical methodology disclosed in respect to FIG. 4, and MPC layer 626 and RTO layer 642 may be MPC layer 424 and RTO layer 436 respectively.

The one or more constraints used to optimize the first cost function may comprise one or more of a minimum concentration of a target component in the outlet retentate flow (e.g. retentate flow 232 of FIG. 2), a maximum concentration of the target component in the outlet retentate flow, and one or more input value limits associated with the CFMF device 602, for example uₘᵢₙ and uₘₐₓ.

The plurality of input values 630 may comprise a concentration factor comprising a first ratio of feed flow to outlet retentate flow and a water factor comprising a second ratio of water flow to feed flow. Optionally, the output interface 638 is further configured to: cause an outlet retentate flow setpoint to be output the CFMF device 602 based on the concentration factor; and/or cause a water flow setpoint to be output the CFMF device 602 based on the water factor. The WFO layer 632 may be further configured to adjust the water factor of the plurality of input values 630 based on the optimal input flow of water 636 for each of the plurality of membranes.

The filtration process may be one of a cross flow UF process, a MF process, or a NF process. For example, the filtration process is a cross flow UF process, and the flow of feed stock comprises a dairy feed stack and the target component in the feed stock of the outlet retentate flow is protein. Other example target components may include: whey protein concentrate, whey protein isolate, milk protein concentrate, milk protein isolate, micellar casein concentrate, micellar casein isolate, and lactoferrin.

Optionally, the system 600 further comprises at least one PLC and an edge-computing device communicatively coupled to the at least one PLC and comprising one or more processors and a memory. For example, the PLC comprises the input interface 604 and the output interface 638, and/or the edge-computing device comprises any of the device control model 610, the membrane control model 618, and the optimizer 624.

Preferably, the water associated with CFMF device 602 is deionised water.

According to one aspect of the present disclosure, system 600 is used during optimizing CFMF process period 306 of FIG. 3.

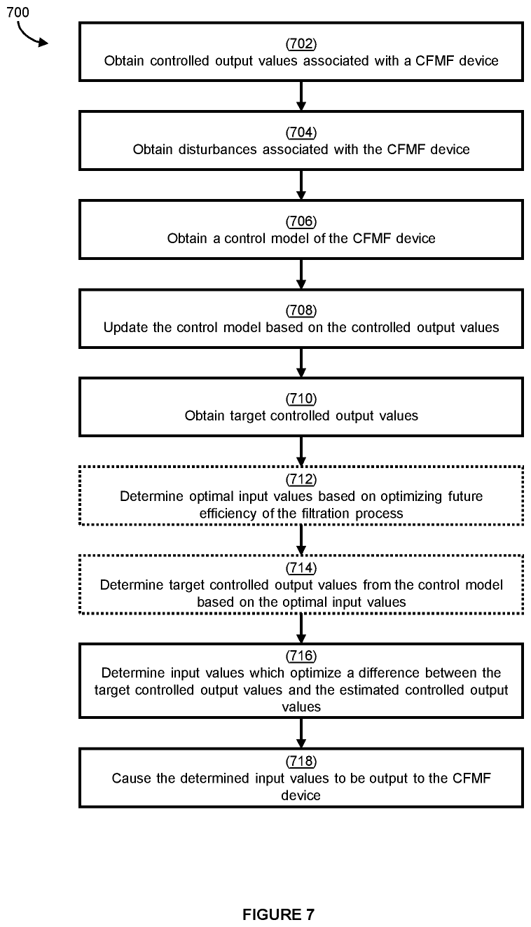

One aspect of the present disclosure relates to the optimization process of FIG. 7.

FIG. 7 is a flowchart illustrating a method for optimizing a filtration process performed at a CFMF device which separates a flow of feed stock and a flow of water into an outlet retentate flow and an outlet permeate flow. The method performed at a control system communicatively coupled to the CFMF device such as those described in detail with reference to FIG. 4 or 6.

The method comprises performing an optimization process 700, the optimization process 700 comprising the following steps.

Step 702 comprises obtaining a plurality of controlled output values associated with the filtration process performed at the CFMF device (e.g. controlled output values 418 of FIG. 4), wherein the plurality of controlled output values comprise: (i) a product concentration value indicative of concentration of a target component of the feed stock in the outlet product flow, and (ii) a total concentration value indicative of concentration of components in the outlet product flow. The obtaining of the plurality of control values is as described with reference to FIG. 4. The product flow may comprise a permeate and/or retentate flow. For example, (i) may be a retentate concentration value indicative of concentration of protein in the outlet retentate flow, and (ii) may be a total concentration value indicative of concentration of all solid components in the outlet retentate flow.

Step 704 comprises obtaining a plurality of disturbance values associated with the CFMF device (e.g. disturbance values 416 of FIG. 4). The obtaining of the plurality of disturbance values 416 is as described with reference to FIG. 4.

Step 706 comprises obtaining a control model of the CFMF device (e.g. control model 420 of FIG. 4), wherein the control model estimates controlled output values from input values according to a state of the control model (e.g. state of the control model 430 of FIG. 4) and the plurality of disturbance values (e.g. plurality of disturbance values 426 of FIG. 4).

Step 708 comprises updating the state of the control model based on the plurality of controlled output values (e.g. plurality of controlled output values 428 of FIG. 4).

The control model and the functionality of the control model used as per steps 704 and 706 is preferably as described in detail with reference to FIG. 4.

Step 710 comprises obtaining a plurality of target controlled output values (e.g. target controlled output values 432 of FIG. 4). The process of the obtaining the target values I described with reference to FIG. 4.

Step 712 and step 714 are optional steps comprising one example for obtaining a plurality of target controlled output values as required in step 710. Therefore, the process may pass directly from step 710 to step 716. In other embodiments the process may pass to one of the two steps, that is to say the process comprises steps 710, 712 and 716 (i.e., missing step 714) or steps 710, 714 and 716 (i.e., missing step 712). Alternatively, the process may comprise all steps i.e., it performs steps 710, 712, 714 and 716.

Step 712 comprises determining a plurality of optimal future input values (e.g. optimal future input values 434 of FIG. 4) which optimize a first cost function, wherein the first cost function estimates a future efficiency of the filtration process according to one or more constraints. Step 714 comprises determining the plurality of target controlled output values from the control model based on the plurality of optimal future input values. The process of steps 712 and 714 is as described with reference to FIG. 4.

Step 716 comprises determining a plurality of input values (e.g. optimal future input values 434 of FIG. 4) which optimize a first difference between the plurality of target controlled output values and a plurality of estimated controlled output values, wherein the plurality of estimated controlled output values are determined from the control model using the plurality of input values; and

Step 718 comprises causing the plurality of input values to be output to the CFMF device thereby decreasing a second difference between the plurality of target controlled output values and a future plurality of controlled output values. The process of steps 716 and 718 is as described with reference to FIG. 4.

The plurality of input values of step 716 may comprise a concentration factor comprising a first ratio of feed flow to outlet retentate flow and a water factor comprising a second ratio of water flow to feed flow. Optionally, step 716 further comprises causing an outlet retentate flow setpoint to be output the CFMF device based on the concentration factor, and/or causing a water flow setpoint to be output to the CFMF device based on the water factor.

Optionally, step 710 further comprises obtaining the plurality of controlled output values from one or more sensors of the CFMF device (e.g. sensors 210 and sensor 240 of FIG. 2). Alternatively, step 710 further comprises obtaining the plurality of controlled output values from the control model of step 706. One example of obtaining the plurality of controlled output values from the control model is described in FIG. 4, where soft-sensors may optionally be used to obtain controlled output values.

Optimization process 700 can be repeatedly performed, as optimization process 700 may form part of an iterative process.

The filtration process of optimization process 700 may be a cross flow UF process, where the flow of feed stock comprises a dairy feed stock and the target component in the feed stock of the retentate flow is protein. Other example target components may include: whey protein concentrate, whey protein isolate, milk protein concentrate, milk protein isolate, micellar casein concentrate, micellar casein isolate, and lactoferrin. Preferably, the water associated with optimization process 700 is a deionised water.

Preferably, optimization process 700 is performed using optimizing system 400.

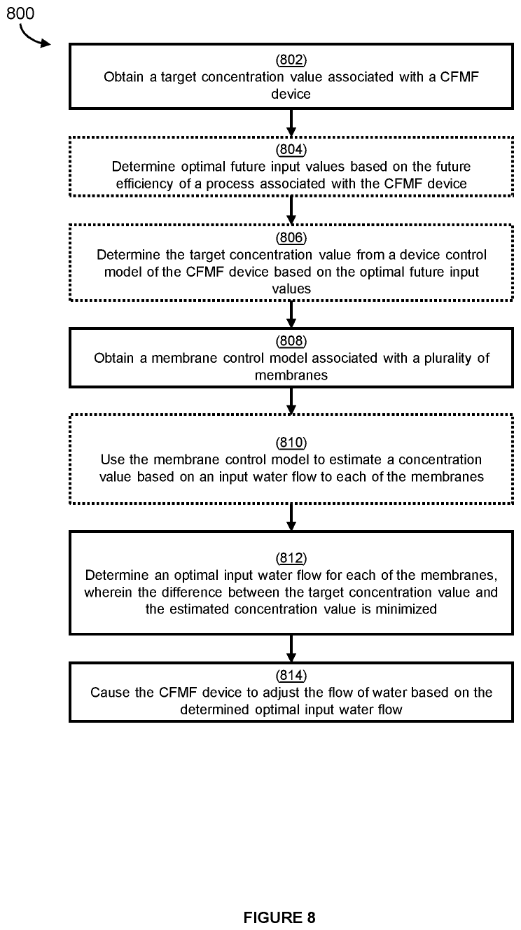

One aspect of the present disclosure relates to the water optimization process of FIG. 8, preferably using the CFMF device 502 of FIG. 5.

FIG. 8 is a flowchart illustrating a method for optimizing water consumption at a cross flow CFMF device comprising a plurality of each of which performing a filtration process which separates a flow of feed stock and a flow of water into an outlet retentate flow and an outlet permeate flow, the method performed at a control system, preferably the water optimizing system 500 of FIG. 5, communicatively coupled to the CFMF device.

The water optimization process 800 comprises the following steps.

Step 802 comprises obtaining a target, such as an optimal, concentration value associated with solid components in the outlet retentate flow. This process is as described with reference to FIG. 5.

One example method for obtaining an optimal concentration value is shown in optional steps 804 and 806. Alternative examples include: obtaining a target/optimal concentration value from a control model, obtaining a target/optimal concentration value by use of soft-sensors, obtaining a target/optimal concentration value from an input interface, or the target/optimal concentration value could be predetermined.

Steps 804 and 806 are optional meaning the process comprises both steps i.e., steps 802, 804, 806. Alternatively, the process may comprise none of the optional steps i.e., the process passes from step 802 to step 808. Alternatively, the process comprises one of the two steps i.e., the process comprises steps 802, 804 and 808 or steps 802, 806 and 808.

Step 804 comprises determining a plurality of optimal future input values which optimize a first cost function, wherein the first cost function estimates a future efficiency of the filtration process according to one or more constraints. The form of the cost function is preferably as described with reference to FIG. 5.

Step 806 comprises determining the target/optimal concentration value from a device control model (e.g. control model 420 of FIG. 4) associated with the CFMF device based on the plurality of optimal future input values, wherein the device control model estimates concentration values from input values according to a state of the device control model (e.g. state of the control model 430 of FIG. 4). This process is also as described with reference to FIG. 5.

Step 808 comprises obtaining a membrane control model, such as membrane control model 512 of FIG. 5, associated with the plurality of membranes, wherein the membrane control model estimates a concentration value (e.g. estimated concentration values 514 of FIG. 5) based on an input flow of water to each of the plurality of membranes (e.g. input water flow 214 of FIG. 2), wherein the concentration value is associated with an estimated concentration of solid components in the outlet retentate flow. Preferably, the process is a described with reference to FIG. 5.

Optionally, the process proceeds to step 810. Alternatively, the process proceeds from step 808 to step 812.

At step 810 to process comprises using the membrane control model to estimate a concentration value based on an input flow of water to each of the plurality of membranes. The membrane control model is as described with reference to FIGS. 4 and 5.

Alternatively, the membrane control model may provide an estimate concentration value in a continual iterative process without a usage requirement.

Step 812 comprises determining an optimal input flow of water (e.g. optimal input flow of water 520 of FIG. 5) for each of the plurality of membranes which minimizes a difference between the target/optimal concentration value and an estimated concentration value (e.g. estimated concentration values 514 of FIG. 5), wherein the estimated concentration value is determined from the membrane control model (e.g. membrane control model 512 of FIG. 5) based on the optimal input flow of water for each of the plurality of membranes.

Step 814 comprises causing the CFMF device to adjust the flow of water at each of the plurality of membranes of the CFMF device according to the optimal input flow of water (e.g. optimal input flow of water 520 of FIG. 5) determined for each of the plurality of membranes. The process of steps 812 and 814 is preferably as disclosed with reference to FIG. 5.

The one or more constraints of step 804 used to optimize the first cost function may comprise one or more of a minimum concentration of the target component in the outlet retentate flow, a maximum concentration of the target component in the outlet retentate flow, and one or more input value limits associated with the CFMF device.

The membrane control model of step 808 may estimate the concentration value based on a plurality of filter specifications associated with the plurality of membranes. For example, each of the plurality of filter specifications comprises a water permeability of an associated membrane, a solute permeability of the associated membrane, a reflection coefficient of the associated membrane, and a membrane area of the associated membrane. In one example, membrane control model may utilize the mass-balance equations previously described in FIG. 4 and FIG. 5.

Optionally, the filtration process of water optimization process 800 is one of a cross flow UF process, a MF process, or a NF process. For example, the filtration process may be a cross flow UF process, and the flow of feed stock comprises a dairy feed stack and the target component in the feed stock of the outlet retentate flow is protein. Other example target components may include: whey protein concentrate, whey protein isolate, milk protein concentrate, milk protein isolate, micellar casein concentrate, micellar casein isolate, and lactoferrin. Preferably, the water associated with water optimization process 800 is a deionised water.

Water optimization process 800 can be repeatedly performed, as water optimization process 800 may form part of an iterative process.

Preferably, water optimization process 800 is performed using water optimizing system 500.

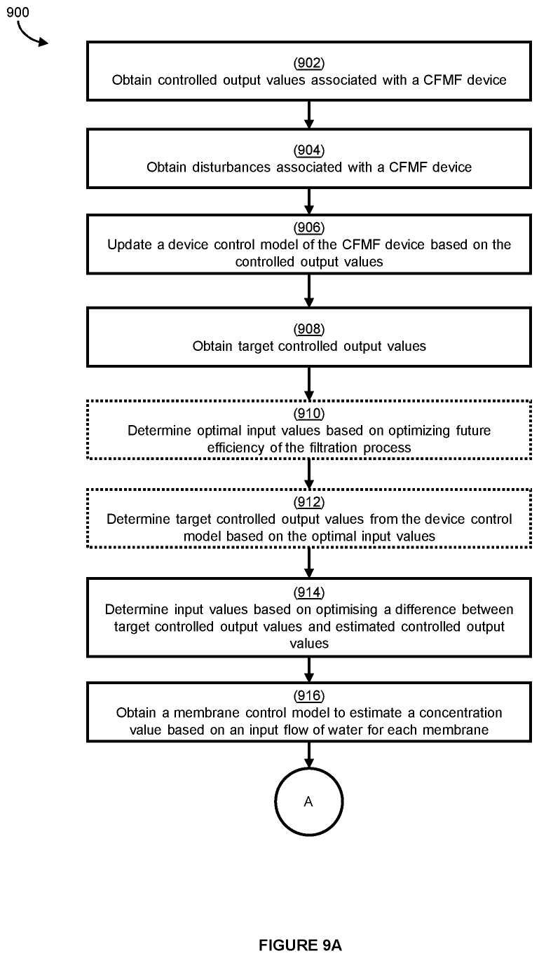

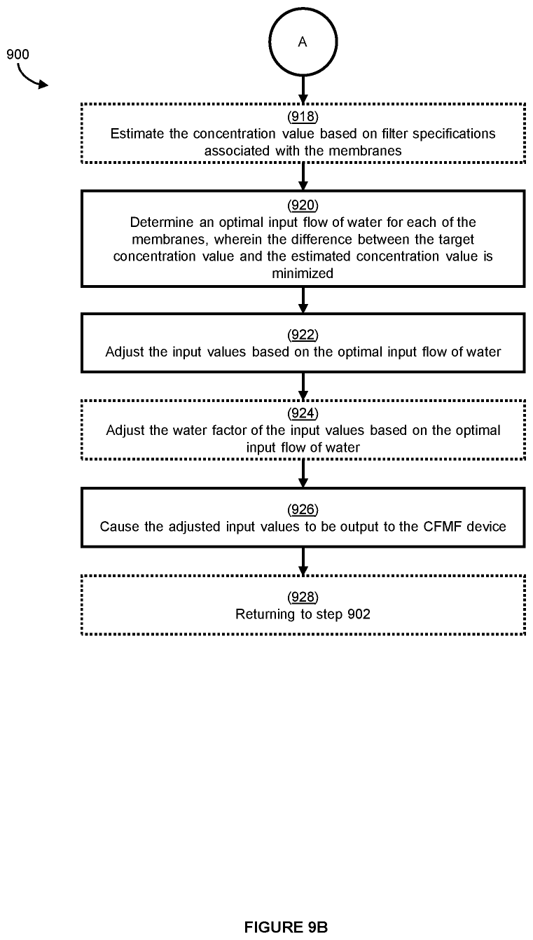

One aspect of the present disclosure relates to the optimization process of FIG. 9, preferably at the CFMF device 602 of FIG. 6.

FIGS. 9A-9B are a flowchart illustrating a method for optimizing a filtration process at a CFMF device comprising a plurality of membranes each of which performing a filtration process which separates a flow of feed stock and a flow of water into an outlet retentate flow and an outlet permeate flow. The method is performed at a control system, preferably the system 600 of FIG. 6 which is communicatively coupled to the CFMF device. The method comprises performing an optimization process 900, wherein the optimization process 900 comprises the following steps.

The steps are as described with reference to the equivalent features in FIGS. 4, 5 and 6.

Step 902 comprises obtaining a plurality of controlled output values (e.g. controlled output values 614 of FIG. 6) associated with the filtration process performed at the CFMF device, wherein the plurality of controlled output values comprise: (i) a product concentration value indicative of concentration of a target component of the feed stock in the outlet product flow, and (ii) a total concentration value indicative of concentration of components in the outlet product flow. The product flow may comprise a permeate and/or retentate flow. For example, (i) may be a retentate concentration value indicative of concentration of protein in the outlet retentate flow, and (ii) may be a total concentration value indicative of concentration of all solid components in the outlet retentate flow.

Step 904 comprises obtaining a plurality of disturbance values (e.g. disturbance values 616 of FIG. 6) associated with the CFMF device.

Step 906 comprises obtaining a device control model of the CFMF device (e.g. device control model 610 of FIG. 6), wherein the device control model estimates controlled output values from input values according to a state of the device control model (e.g. the state of the device control model 612 of FIG. 6) and the plurality of disturbance values (e.g. disturbance values 616 of FIG. 6), and updating the state of the device control model based on the plurality of controlled output values (e.g. controlled output values 614 of FIG. 6).

Step 908 comprises obtaining a plurality of target controlled output values (e.g. target controlled output values 628 of FIG. 6).

One example method for obtaining a plurality of target controlled output values is shown in step 910 and step 912. Alternative examples include: obtaining an optimal concentration value from a control model, obtaining an optimal concentration value by use of soft-sensors, obtaining an optimal concentration value from an input interface, or the optimal concentration value could be predetermined. In other embodiments, the optimal concentration value may be a target concentration value.

Steps 910 and 912 are optional steps. Therefore, the process may pass directly from step 908 to step 914. In other embodiments the process may pass to one of the two steps, that is to say the process comprises steps 908, 910 and 914 (i.e., missing step 912) or steps 908, 912 and 914 (i.e., missing step 910). Alternatively, the process may comprise all steps i.e., it performs steps 908, 910, 912 and 914. Step 910 comprises determining a plurality of optimal future input values which optimize a first cost function, wherein the first cost function estimates a future efficiency of the filtration process according to one or more constraints.

Step 912 comprises determining the plurality of target controlled output values (e.g. target controlled output values 628 of FIG. 6) from the device control model (e.g. device control model 610 of FIG. 6) based on the plurality of optimal future input values.

Step 914 comprises determining a plurality of input values (e.g. input values 630 of FIG. 6) which optimize a first difference between the plurality of target controlled output values (e.g. target controlled output values 628 of FIG. 6) and a plurality of estimated controlled output values, wherein the plurality of estimated controlled output values are determined from the device control model (e.g. device control model 610 of FIG. 6) using the plurality of input values (e.g. input values 630 of FIG. 6).

Step 916 comprises obtaining a membrane control model (e.g. membrane control model 618 of FIG. 6) associated the plurality of membranes, wherein the membrane control model estimates a concentration value (e.g. estimated concentration value 620) based on an input flow of water (e.g. input flow of water 622 of FIG. 6) to each of the plurality of membranes, wherein the concentration value is associated with an estimated concentration of solid components in the outlet retentate flow.

Step 918 is optional. Therefore the process may pass directly from step 916 to 920 or the process includes step 918.

Step 918 comprises using the membrane control model (e.g. membrane control model 618 of FIG. 6) to estimate a concentration value (e.g. estimated concentration value 620), wherein the membrane control model may be further configured to estimate the concentration value based on a plurality of filter specifications associated with the plurality of membranes, such as those disclosed in FIG. 4. In one example, the plurality of filter specifications comprises a water permeability of an associated membrane, Lₚ, solute concentration of the associated membrane, c̅ₛ, the solute permeability of the associated membrane, ω, and the reflection coefficient of the associated membrane, σᵣ, and a membrane area of the associated membrane which can be used to calculate pressure. Depending on the operation of the membrane control model of step 916, step 918 may be performed in step 916. Therefore, step 918 is optional.

Step 920 comprises determining an optimal input flow (i.e. optimal input flow of water 636 of FIG. 6) of water for each of the plurality of membranes which minimizes a difference between the optimal concentration value (e.g. target controlled output values 628 of FIG. 6) and an estimated concentration value (e.g. estimated concentration value 620), wherein the estimated concentration value is determined from the membrane control model based on the optimal input flow of water for each of the plurality of membranes.

Step 922 comprises adjusting the plurality of input values (e.g. input values 630 of FIG. 6) according to the optimal input flow of water (i.e. optimal input flow of water 636 of FIG. 6) for each of the plurality of membranes. Optionally, the plurality of input values of step 922 comprise a concentration factor comprising a first ratio of feed flow to outlet retentate flow and a water factor comprising a second ratio of water flow to feed flow.

Step 924 comprises adjusting the water factor of the plurality of input values (e.g. input values 630 of FIG. 6) based on the optimal input flow of water (e.g. optimal input flow of water 636 of FIG. 6) for each of the plurality of membranes. Depending on whether the water factor is included within the plurality of input values of step 922, step 924 may be performed in step 922. Therefore, step 924 is optional, that is to say in some embodiments the process passes from step 922 to 926.

Step 926 comprises causing the plurality of input values (e.g. input values 630 of FIG. 6) to be output to the CFMF device thereby decreasing a second difference between the plurality of target controlled output values and a future plurality of controlled output values.

Step 928 comprises returning to step 902 to repeat the process. Therefore, the process may be iterative. However, it is understood that if, for example, an exit criterion is met, or optimization process 900 is otherwise not an iterative process, the optimization process 900 may not require repetition. Therefore, step 928 is optional.

Optionally, the filtration process associated with the optimization process 900 is one of a cross flow UF process, a MF process, or a NF process. For example, the filtration process is a cross flow UF process, and/or the flow of feed stock comprises a dairy feed stock and the target component in the feed stock of the retentate flow is protein. Other example target components may include: whey protein concentrate, whey protein isolate, milk protein concentrate, milk protein isolate, micellar casein concentrate, micellar casein isolate, and lactoferrin. Preferably, the water associated with the optimization process 900 is a deionised water.

Preferably, optimization process 900 is performed using system 600.

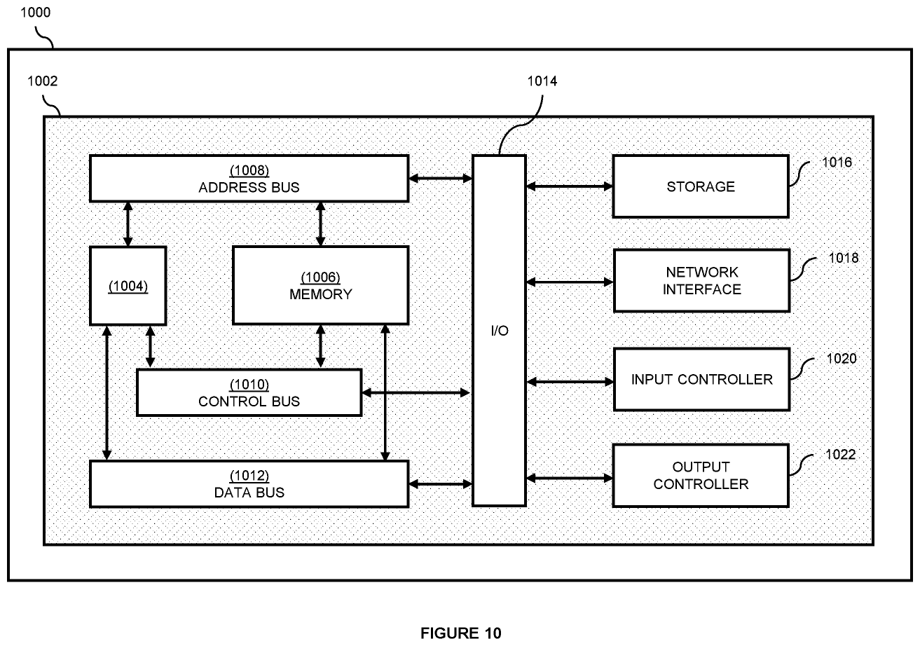

FIG. 10 shows an example computing system for optimization. Specifically, FIG. 10 shows a block diagram of an embodiment of a computing system according to example embodiments of the present disclosure.

Computing system 1000 can be configured to perform any of the operations disclosed herein such as, for example, any of the operations discussed with reference to the functional units described in relation to FIGS. 7, 8, 9A and 9B. Computing system includes one or more computing device(s) 1002. Computing device(s) 1002 of computing system 1000 comprise one or more processors 1004 and memory 1006. One or more processors 1004 can be any general purpose processor(s) configured to execute a set of instructions. For example, one or more processors 1004 can be one or more general-purpose processors, one or more field programmable gate array (FPGA), and/or one or more application specific integrated circuits (ASIC). In one embodiment, one or more processors 1004 include one processor. Alternatively, one or more processors 1004 include a plurality of processors that are operatively connected. One or more processors 1004 are communicatively coupled to memory 1006 via address bus 1008, control bus 1010, and data bus 1012. Memory 1006 can be a random access memory (RAM), a read only memory (ROM), a persistent storage device such as a hard drive, an erasable programmable read only memory (EPROM), and/or the like. Computing device(s) 1002 further comprise I/O interface 1014 communicatively coupled to address bus 1008, control bus 1010, and data bus 1012.

Memory 1006 can store information that can be accessed by one or more processors 1004. For instance, memory 1006 (e.g., one or more non-transitory computer-readable storage mediums, memory devices) can include computer-readable instructions (not shown) that can be executed by one or more processors 1004. The computer-readable instructions can be software written in any suitable programming language or can be implemented in hardware. Additionally, or alternatively, the computer-readable instructions can be executed in logically and/or virtually separate threads on one or more processors 1004. For example, memory 1006 can store instructions (not shown) that when executed by one or more processors 1004 cause one or more processors 1004 to perform operations such as any of the operations and functions for which computing system 1000 is configured, as described herein. In addition, or alternatively, memory 1006 can store data (not shown) that can be obtained, received, accessed, written, manipulated, created, and/or stored. The data can include, for instance, the data and/or information described herein in relation to FIGS. 1 to 9B. In some implementations, computing device(s) 1002 can obtain from and/or store data in one or more memory device(s) that are remote from the computing system 1000.

Computing system 1000 further comprises storage unit 1016, network interface 1018, input controller 1020, and output controller 1022. Storage unit 1016, network interface 1018, input controller 1020, and output controller 1022 are communicatively coupled to central control unit via I/O interface 1014.

Storage unit 1016 is a computer readable medium, preferably a non-transitory computer readable medium, comprising one or more programs, the one or more programs comprising instructions which when executed by the one or more processors 1004 cause computing system 1000 to perform the method steps of the present disclosure. Alternatively, storage unit 1016 is a transitory computer readable medium. Storage unit 1016 can be a persistent storage device such as a hard drive, a cloud storage device, or any other appropriate storage device.

Network interface 1018 can be a Wi-Fi module, a network interface card, a Bluetooth module, and/or any other suitable wired or wireless communication device. In an embodiment, network interface 1018 is configured to connect to a network such as a local area network (LAN), or a wide area network (WAN), the Internet, or an intranet.

At this point it should be noted that optimization in accordance with the present disclosure as described above may involve the processing of input data and the generation of output data to some extent. This input data processing and output data generation may be implemented in hardware or software. For example, specific electronic components may be employed in a control module or similar or related circuitry for implementing the functions associated optimization in accordance with the present disclosure as described above. Alternatively, one or more processors operating in accordance with instructions may implement the functions associated with optimization in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes. Accordingly, the statements set forth below should be construed in view of the full breadth and spirit of the present disclosure as described herein.

### NUMBERED STATEMENTS OF INVENTION

1. A system for optimizing a filtration process performed at a cross flow membrane filtration (CFMF) device which separates a flow of feed stock and a flow of water into an outlet retentate flow and an outlet permeate flow, the system comprising:
   an input interface communicatively coupled to the CFMF device and configured to:
      obtain a plurality of controlled output values associated with the filtration process performed at the CFMF device, wherein the plurality of controlled output values comprise: (i) a product concentration value indicative of concentration of a target component of the feed stock in the outlet product flow, and (ii) a total concentration value indicative of concentration of solid components in the outlet product flow; and
      obtain a plurality of disturbances associated with the CFMF device;
   a control model of the CFMF device, wherein the control model estimates controlled output values from input values according to a state of the control model and the plurality of disturbances;
   an optimizer comprising a model predictive control (MPC) layer, wherein the optimizer is configured to update the state of the control model based on the plurality of controlled output values, and wherein the MPC layer is configured to:
      obtain a plurality of target controlled output values; and
      determine a plurality of input values which optimize a first difference between the plurality of target controlled output values and a plurality of estimated controlled output values, wherein the plurality of estimated controlled output values are determined from the control model using the plurality of input values; and
   an output interface communicatively coupled to the CFMF device and configured to cause the plurality of input values to be output to the CFMF device thereby decreasing a second difference between the plurality of target controlled output values and a future plurality of controlled output values.
2. The system of statement 1 wherein the filtration process is one of a cross flow ultrafiltration (UF) process, a microfiltration (MF) process, or a nanofiltration (NF) process.
3. The system of statement 2 wherein the filtration process is a cross flow UF process.
4. The system of statement any preceding statement wherein the flow of feed stock comprises a dairy feed stock and the target component in the feed stock of the outlet retentate flow is protein.
5. The system of any preceding statement wherein the plurality of controlled output values are obtained from one or more sensors of the CFMF device.
6. The system of any of statements 1 to 4 wherein the plurality of controlled output values are obtained from a soft-sensor.
7. The system of statement 6 wherein the soft-sensor comprises the control model of the CFMF device such that the plurality of controlled output values are estimated by the control model.
8. The system of any preceding statement wherein the plurality of disturbances are obtained from one or more sensors of the CFMF device.
9. The system of any preceding statement wherein the control model comprises a state space model.
10. The system of statement 9 wherein the state space model is a discrete time model.
11 The system of any preceding statement wherein the control model is a linear control model.
12. The system of any preceding statement wherein the state of the control model is updated using a time-varying Kalman filter.
13. The system of any preceding statement wherein the optimizer further comprises a real-time optimization (RTO) layer configured to determine the plurality of target controlled output values obtained by the MPC layer.
14. The system of statement 13 wherein the RTO layer is configured to:
   determine a plurality of optimal future input values which optimize a first cost function, wherein the first cost function estimates a future efficiency of the filtration process according to one or more constraints; and
   determine the plurality of target controlled output values from the control model based on the plurality of optimal future input values.
15. The system of any preceding statement wherein the one or more constraints used to optimize the first cost function comprises one or more of a minimum concentration of the target component in the outlet retentate flow, a maximum concentration of the target component in the outlet retentate flow, and one or more input value limits associated with the CFMF device.
16. The system of any preceding statement wherein the plurality of optimal future input values which optimize the first cost function are determined using an interior-point algorithm for a non-linear problem.
17. The system of any preceding statement wherein the plurality of input values which optimize the first difference between the plurality of target controlled output values and the plurality of estimated controlled output values are determined using a quadratic program solver.
18. The system of statement 17 wherein the quadratic program solver is one of an active set method, an interior-point method, and a first-order gradient method.
19. The system of any preceding statement wherein the plurality of input values comprise a concentration factor comprising a first ratio of feed flow to outlet retentate flow and a water factor comprising a second ratio of water flow to feed flow.
20. The system of statement 19 wherein the output interface is further configured to cause an outlet retentate flow setpoint to be output the CFMF device based on the concentration factor.
21 The system of either of statements 19 or 20 wherein the output interface is further configured to cause a water flow setpoint to be output the CFMF device based on the water factor.
22. The system of any preceding statement wherein the water is a deionised water.
23. The system of any preceding statement wherein the system further comprises:
   at least one programmable logic controller (PLC); and
   an edge-computing device communicatively coupled to the at least one PLC and comprising one or more processors and a memory.
24. The system of statement 23 wherein the PLC comprises the input interface and the output interface.
25. The system of either of statements 23 or 24 wherein the edge-computing device comprises the control model and the optimizer.
26. A method for optimizing a filtration process performed at a cross flow membrane filtration (CFMF) device which separates a flow of feed stock and a flow of water into an outlet retentate flow and an outlet permeate flow, the method performed at a control system communicatively coupled to the CFMF device, the method comprising:
   performing an optimization process, the optimization process comprising:
   obtaining a plurality of controlled output values associated with the filtration process performed at the CFMF device, wherein the plurality of controlled output values comprise: (i) a product concentration value indicative of concentration of a target component of the feed stock in the outlet product flow, and (ii) a total concentration value indicative of concentration of components in the outlet product flow;
   obtaining a plurality of disturbances associated with the CFMF device;
   obtaining a control model of the CFMF device, wherein the control model estimates controlled output values from input values according to a state of the control model and the plurality of disturbances;
   updating the state of the control model based on the plurality of controlled output values;
   obtaining a plurality of target controlled output values;
   determining a plurality of input values which optimize a first difference between the plurality of target controlled output values and a plurality of estimated controlled output values, wherein the plurality of estimated controlled output values are determined from the control model using the plurality of input values; and
   causing the plurality of input values to be output to the CFMF device thereby decreasing a second difference between the plurality of target controlled output values and a future plurality of controlled output values.
27. The method of statement 26 wherein the filtration process is one of a cross flow ultrafiltration (UF) process, a microfiltration (MF) process, or a nanofiltration (NF) process.
28. The method of statement 27 wherein the filtration process is a cross flow UF process.
29. The method of statement any of statements 26 to 28 wherein the flow of feed stock comprises a dairy feed stock and the target component in the feed stock of the retentate flow is protein.
30. The method of any of statements 26 to 29 wherein the step of obtaining the plurality of target controlled output values further comprises:
   determining a plurality of optimal future input values which optimize a first cost function, wherein the first cost function estimates a future efficiency of the filtration process according to one or more constraints; and
   determining the plurality of target controlled output values from the control model based on the plurality of optimal future input values.
31. The method of any of statements 26 to 30 wherein the step of obtaining the plurality of controlled output values associated with the filtration process performed at the CFMF device further comprises:
   obtaining the plurality of controlled output values from one or more sensors of the CFMF device.
32. The method of any of statements 26 to 30 wherein the step of obtaining the plurality of controlled output values associated with the filtration process performed at the CFMF device further comprises:
   obtaining the plurality of controlled output values from the control model.
33. The method of any of statements 26 to 32 wherein the step of obtaining the plurality of disturbances associated with the CFMF device further comprises:
   obtaining the plurality of disturbances from one or more sensors of the CFMF device.
34. The method of any of statements 26 to 33 wherein the plurality of input values comprise a concentration factor comprising a first ratio of feed flow to outlet retentate flow and a water factor comprising a second ratio of water flow to feed flow.
35. The method of statement 34 wherein the step of causing the plurality of input values to be output to the CFMF device further comprises:
   causing an outlet retentate flow setpoint to be output the CFMF device based on the concentration factor.
36. The method of either of statements 34 or 35 wherein the step of causing the plurality of input values to be output to the CFMF device further comprises:
   causing a water flow setpoint to be output to the CFMF device based on the water factor.
37 The method of any of statements 26 to 36 comprising repeatedly performing the optimization process.
38. A computer-readable medium storing instructions which, when executed by a system comprising one or more processors, cause the system to carry out the steps of any of statements 26 to 37.
39. A cross flow membrane filtration device comprising the system of any of statements 1-25.
40. A system for optimizing water consumption at a cross flow membrane filtration (CFMF) device comprising a plurality of membranes each of which performing a filtration process which separates a flow of feed stock and a flow of water into an outlet retentate flow and an outlet permeate flow, the system comprising:
   a membrane control model associated with the plurality of membranes, wherein the membrane control model is configured to:
      estimate a concentration value based on an input flow of water to each of the plurality of membranes, wherein the concentration value is associated with an estimated concentration of solid components in the outlet retentate flow;
   an optimization unit configured to:
      obtain a target concentration value associated with solid components in the outlet retentate flow; and
      determine an optimal input flow of water for each of the plurality of membranes which minimizes a difference between the target concentration value and an estimated concentration value, wherein the estimated concentration value is determined from the membrane control model based on the optimal input flow of water for each of the plurality of membranes;
   an output interface communicatively coupled to the CFMF device and configured to cause the CFMF device to adjust the flow of water at each of the plurality of membranes of the CFMF device according to the optimal input flow of water determined for each of the plurality of membranes.
41. The system of statement 40 wherein the filtration process is one of a cross flow ultrafiltration (UF) process, a microfiltration (MF) process, or a nanofiltration (NF) process.
42. The system of statement 41 wherein the filtration process is a cross flow UF process.
43. The system of any of statements 40 to 42 wherein the flow of feed stock comprises a dairy feed stock and the target component in the feed stock of the retentate flow is protein.
44. The system of any of statements 40 to 43 further comprising a real-time optimizer (RTO) wherein the target concentration value is obtained from the RTO.
45. The system of statement 44 wherein the RTO is configured to:
   determine a plurality of optimal future input values which optimize a first cost function, wherein the first cost function estimates a future efficiency of the filtration process according to one or more constraints; and
   determine the target concentration value from a device control model associated with the CFMF device based on the plurality of optimal future input values, wherein the control model estimates concentration values from input values according to a state of the device control model.
46 The system of statement 45 wherein the one or more constraints used to optimize the first cost function comprises one or more of a minimum concentration of a target component in the outlet retentate flow, a maximum concentration of the target component in the outlet retentate flow, and one or more input value limits associated with the CFMF device.
47. The system of any of statements 40 to 46 wherein the membrane control model is further configured to estimate the concentration value based on a plurality of filter specifications associated with the plurality of membranes.
48. The system of statement 47 wherein each of the plurality of filter specifications comprises a water permeability of an associated membrane, a solute permeability of the associated membrane, a reflection coefficient of the associated membrane, and a membrane area of the associated membrane.
49. The system of any of statements 40 to 48 wherein the membrane control model comprises one of a physics-based model, a statistical model, or a machine learning model.
50. The system of any of statements 40 to 49 wherein the optimal input flow of water for each of the plurality of membranes is determined using a sequential quadratic programming optimization method.
51. The system of any of statements 40 to 49 wherein the optimal input flow of water for each of the plurality of membranes is determined using one of a direct search method, an extremum seeking method, or a trial-and-error method.
52. The system of any of statements 40 to 51 wherein the water is a deionised water.
53. A method for optimizing water consumption at a cross flow membrane filtration (CFMF) device comprising a plurality of membranes each of which performing a filtration process which separates a flow of feed stock and a flow of water into an outlet retentate flow and an outlet permeate flow, the method performed at a control system communicatively coupled to the CFMF device, the method comprising:
   performing an optimization process, wherein the optimization process comprises:
   obtaining a target concentration value associated with solid components in the outlet retentate flow;
   obtaining a membrane control model associated with the plurality of membranes, wherein the membrane control model estimates a concentration value based on an input flow of water to each of the plurality of membranes, wherein the concentration value is associated with an estimated concentration of solid components in the outlet retentate flow;
   determining an optimal input flow of water for each of the plurality of membranes which minimizes a difference between the target concentration value and an estimated concentration value, wherein the estimated concentration value is determined from the membrane control model based on the optimal input flow of water for each of the plurality of membranes; and
   causing the CFMF device to adjust the flow of water at each of the plurality of membranes of the CFMF device according to the optimal input flow of water determined for each of the plurality of membranes.
54. The method of statement 53 wherein the filtration process is one of a cross flow ultrafiltration (UF) process, a microfiltration (MF) process, or a nanofiltration (NF) process.
55. The method of statement 54 wherein the filtration process is a cross flow UF process.
56. The method of statement 55 wherein the flow of feed stock comprises a dairy feed stack and the target component in the feed stock of the outlet retentate flow is protein.
57. The method of any of statements 54 to 56 wherein the step of obtaining the target concentration value further comprises:
   determining a plurality of optimal future input values which optimize a first cost function, wherein the first cost function estimates a future efficiency of the filtration process according to one or more constraints; and
   determining the target concentration value from a device control model associated with the CFMF device based on the plurality of optimal future input values, wherein the control model estimates concentration values from input values according to a state of the device control model.
58. The method of statement 57 wherein the one or more constraints used to optimize the first cost function comprises one or more of a minimum concentration of the target component in the outlet retentate flow, a maximum concentration of the target component in the outlet retentate flow, and one or more input value limits associated with the CFMF device.
59. The method of any of statements 53 to 58 wherein the membrane control model estimates the concentration value based on a plurality of filter specifications associated with the plurality of membranes.
60. The method of statement 59 wherein each of the plurality of filter specifications comprises a water permeability of an associated membrane, a solute permeability of the associated membrane, a reflection coefficient of the associated membrane, and a membrane area of the associated membrane.
61. The method of any of statements 53 to 60 further comprising repeatedly performing the optimization process.
62. A computer-readable medium storing instructions which, when executed by a system comprising one or more processors, cause the system to carry out the steps of any of statements 53 to 61.
63. A cross flow membrane filtration device comprising the system of any of statements 40-52.
64. A system for optimizing a filtration process performed at a cross flow membrane filtration (CFMF) device comprising a plurality of membranes each of which performing a filtration process which separates a flow of feed stock and a flow of water into an outlet retentate flow and an outlet permeate flow, the system comprising:
   an input interface communicatively coupled to the CFMF device and configured to:
      obtain a plurality of controlled output values associated with the filtration process performed at the CFMF device, wherein the plurality of controlled output values comprise: (i) a product concentration value indicative of concentration of a target component of the feed stock in the outlet product flow, and (ii) a total concentration value indicative of concentration of components in the outlet product flow; and
      obtain a plurality of disturbances associated with the CFMF device;
   a device control model associated with the CFMF device, wherein the device control model estimates controlled output values from input values according to a state of the device control model and the plurality of disturbances;
   a membrane control model associated the plurality of membranes, wherein the membrane model is configured to estimate a concentration value based on an input flow of water to each of the plurality of membranes, wherein the concentration value is associated with an estimated concentration of solid components in the outlet retentate flow;
   an optimizer comprising a model predictive control (MPC) layer and a water flow optimization (WFO) layer, wherein the optimizer is configured to update the state of the device control model based on the plurality of controlled output values, and wherein the MPC layer is configured to:
      obtain a plurality of target controlled output values; and
      determine a plurality of input values which optimize a first difference between the plurality of target controlled output values and a plurality of estimated controlled output values, wherein the plurality of estimated controlled output values are determined from the device control model using the plurality of input values; and
   wherein the WFO layer is configured to:
      obtain a target concentration value associated with solid components in the outlet retentate flow;
      determine an optimal input flow of water for each of the plurality of membranes which minimizes a difference between the target concentration value and an estimated concentration value, wherein the estimated concentration value is determined from the membrane control model based on the optimal input flow of water for each of the plurality of membranes; and
      adjust the plurality of input values determined by the MPC layer based on the optimal input flow of water for each of the plurality of membranes;
   an output interface communicatively coupled to the CFMF device and configured to cause the plurality of input values to be output to the CFMF device thereby decreasing a second difference between the plurality of target controlled output values and a future plurality of controlled output values.
65. The system of statement 64 wherein the filtration process is one of a cross flow ultrafiltration (UF) process, a microfiltration (MF) process, or a nanofiltration (NF) process.
66. The system of statement 65 wherein the filtration process is a cross flow UF process.
67. The system of any of statements 64 to 66 wherein the flow of feed stock comprises a dairy feed stock and the target component in the feed stock of the retentate flow is protein.
68. The system of any of statements 64 to 67 wherein the optimizer further comprises a real-time optimization (RTO) layer configured to determine the plurality of target controlled output values obtained by the MPC layer.
69. The system of statement 68 wherein the RTO layer is configured to:
   determine a plurality of optimal future input values which optimize a first cost function, wherein the first cost function estimates a future efficiency of the filtration process according to one or more constraints; and
   determine the plurality of target controlled output values from the device control model based on the plurality of optimal future input values.
70. The system of statement 69 wherein the RTO layer is further configured to:
   determine the target concentration value from the device control model based on the plurality of optimal future input values.
71. The system of either of statements 69 or 70 wherein the one or more constraints used to optimize the first cost function comprises one or more of a minimum concentration of a target component in the outlet retentate flow, a maximum concentration of the target component in the outlet retentate flow, and one or more input value limits associated with the CFMF device.
72. The system of any of statements 64 to 71 wherein the plurality of input values comprise a concentration factor comprising a first ratio of feed flow to outlet retentate flow and a water factor comprising a second ratio of water flow to feed flow.
73. The system of statement 72 wherein the output interface is further configured to cause an outlet retentate flow setpoint to be output the CFMF device based on the concentration factor.
74. The system of either of statements 72 or 73 wherein the output interface is further configured to cause a water flow setpoint to be output the CFMF device based on the water factor.
75. The system of any of statements 72 to 74 wherein the water flow optimization unit is further configured to adjust the water factor of the plurality of input values based on the optimal input flow of water for each of the plurality of membranes.
76. The system of any of statements 64 to 75 wherein the membrane control model is further configured to estimate the concentration value based on a plurality of filter specifications associated with the plurality of membranes.
77. The system of statement 76 wherein each of the plurality of filter specifications comprises a water permeability of an associated membrane, a solute permeability of the associated membrane, a reflection coefficient of the associated membrane, and a membrane area of the associate membrane.
78. The system of any of statements 64 to 77 wherein the water is a deionised water.
79. A method for optimizing a filtration process at a cross flow membrane filtration (CFMF) device comprising a plurality of membranes each of which performing a filtration process which separates a flow of feed stock and a flow of water into an outlet retentate flow and an outlet permeate flow, the method performed at a control system communicatively coupled to the CFMF device, the method comprising:
   performing an optimization process, wherein the optimization process comprises:
   obtaining a plurality of controlled output values associated with the filtration process performed at the CFMF device, wherein the plurality of controlled output values comprise: (i) a product concentration value indicative of concentration of a target component of the feed stock in the outlet product flow, and (ii) a total concentration value indicative of concentration of components in the outlet product flow;
   obtaining a plurality of disturbances associated with the CFMF device;
   obtaining a device control model of the CFMF device, wherein the device control model estimates controlled output values from input values according to a state of the device control model and the plurality of disturbances;
   updating the state of the device control model based on the plurality of controlled output values;
   obtaining a plurality of target controlled output values;
   determining a plurality of input values which optimize a first difference between the plurality of target controlled output values and a plurality of estimated controlled output values, wherein the plurality of estimated controlled output values are determined from the device control model using the plurality of input values;
   obtaining a membrane control model associated the plurality of membranes, wherein the membrane control model estimates a concentration value based on an input flow of water to each of the plurality of membranes, wherein the concentration value is associated with an estimated concentration of solid components in the outlet retentate flow;
   determining an optimal input flow of water for each of the plurality of membranes which minimizes a difference between the optimal concentration value and an estimated concentration value, wherein the estimated concentration value is determined from the membrane control model based on the optimal input flow of water for each of the plurality of membranes;
   adjusting the plurality of input values according to the optimal input flow of water for each of the plurality of membranes; and
   causing the plurality of input values to be output to the CFMF device thereby decreasing a second difference between the plurality of target controlled output values and a future plurality of controlled output values.
80. The method of statement 79 wherein the filtration process is one of a cross flow ultrafiltration (UF) process, a microfiltration (MF) process, or a nanofiltration (NF) process.
81. The method of statement 81 wherein the filtration process is a cross flow UF process.
82. The method of any of statements 79 to 81 wherein the flow of feed stock comprises a dairy feed stock and the target component in the feed stock of the retentate flow is protein.
83. The method of any of statements 79 to 82 wherein the step of obtaining the plurality of target controlled output values further comprises:
   determining a plurality of optimal future input values which optimize a first cost function, wherein the first cost function estimates a future efficiency of the filtration process according to one or more constraints; and
   determining the plurality of target controlled output values from the device control model based on the plurality of optimal future input values.
84. The method of statement 83 wherein the step of obtaining the target concentration value further comprises:
   determining the target concentration value from the device control model based on the plurality of optimal future input values.
85. The method of any of statements 79 to 84 wherein the plurality of input values comprise a concentration factor comprising a first ratio of feed flow to outlet retentate flow and a water factor comprising a second ratio of water flow to feed flow.
86. The method of statement 85 wherein the step of adjusting the plurality of input values comprises:
   adjusting the water factor of the plurality of input values based on the optimal input flow of water for each of the plurality of membranes.
87. The method of any of statements 79 to 86 wherein the membrane control model is further configured to estimate the concentration value based on a plurality of filter specifications associated with the plurality of membranes.
88. The method of statement 87 wherein each of the plurality of filter specifications comprises a water permeability of an associated membrane, a solute permeability of the associated membrane, a reflection coefficient of the first membrane, and a membrane area of the associated membrane
89. The method of any of statements 79 to 88 wherein the water is a deionised water.
90 The method of any of statements 79 to 89 further comprising repeatedly performing the optimization process.
91. A computer-readable medium storing instructions which, when executed by a system comprising one or more processors, cause the system to carry out the steps of any of statements 79 to 90.
92. A cross flow membrane filtration device comprising the system of any of statements 64-78.

1. A system for optimizing a filtration process performed at a cross flow membrane filtration (CFMF) device which separates a flow of feed stock and a flow of water into an outlet retentate flow and an outlet permeate flow, the system comprising:
an input interface communicatively coupled to the CFMF device and configured to:
obtain a plurality of controlled output values associated with the filtration process performed at the CFMF device, wherein the plurality of controlled output values comprise: (i) a product concentration value indicative of concentration of a target component of the feed stock in the outlet product flow, and (ii) a total concentration value indicative of concentration of solid components in the outlet product flow; and
obtain a plurality of disturbances associated with the CFMF device;
a control model of the CFMF device, wherein the control model estimates controlled output values from input values according to a state of the control model and the plurality of disturbances;
an optimizer comprising a model predictive control (MPC) layer, wherein the optimizer is configured to update the state of the control model based on the plurality of controlled output values, and wherein the MPC layer is configured to:
obtain a plurality of target controlled output values; and
determine a plurality of input values which optimize a first difference between the plurality of target controlled output values and a plurality of estimated controlled output values, wherein the plurality of estimated controlled output values are determined from the control model using the plurality of input values; and
an output interface communicatively coupled to the CFMF device and configured to cause the plurality of input values to be output to the CFMF device thereby decreasing a second difference between the plurality of target controlled output values and a future plurality of controlled output values.

2. The system of claim 1, wherein the filtration process is a cross flow ultrafiltration process.

3. The system of claim 1, wherein the flow of feed stock comprises a dairy product, in particular whey, and the target component in the feed stock of the outlet retentate flow is protein.

4. The system of claim 1, wherein the plurality of controlled output values are obtained from one or more sensors of the CFMF device.

5. The system of claim 1, wherein the optimizer further comprises a real time optimization (RTO) layer configured to determine the plurality of target controlled output values obtained by the MPC layer.

6. The system of claim 5, wherein the RTO layer is configured to:
determine a plurality of optimal future input values which optimize a first cost function, wherein the first cost function estimates a future efficiency of the filtration process according to one or more constraints; and
determine the plurality of target controlled output values from the control model based on the plurality of optimal future input values.

7. The system of claim 1, wherein the plurality of input values comprise a concentration factor comprising a first ratio of feed flow to outlet retentate flow and a water factor comprising a second ratio of water flow to feed flow.

8. The system of claim 1, wherein the system further comprises:
at least one programmable logic controller (PLC); and
an edge-computing device communicatively coupled to the at least one PLC and comprising one or more processors and a memory;
wherein the PLC comprises the input interface and the output interface, and wherein the edge-computing device comprises the control model and the optimizer.

9. The system of claim 1, wherein the system further comprises the CEMF device.

10. A method for optimizing a filtration process performed at a cross flow membrane filtration (CFMF) device which separates a flow of feed stock and a flow of water into an outlet retentate flow and an outlet permeate flow, the method performed at a control system communicatively coupled to the CFMF device, the method comprising:
obtaining a plurality of controlled output values associated with the filtration process performed at the CFMF device, wherein the plurality of controlled output values comprise: (i) a product concentration value indicative of concentration of a target component of the feed stock in the outlet product flow, and (ii) a total concentration value indicative of concentration of components in the outlet product flow;
obtaining a plurality of disturbances associated with the CFMF device;
obtaining a control model of the CFMF device, wherein the control model estimates controlled output values from input values according to a state of the control model and the plurality of disturbances;
updating the state of the control model based on the plurality of controlled output values;
obtaining a plurality of target controlled output values;
determining a plurality of input values which optimize a first difference between the plurality of target controlled output values and a plurality of estimated controlled output values, wherein the plurality of estimated controlled output values are determined from the control model using the plurality of input values; and
causing the plurality of input values to be output to the CFMF device thereby decreasing a second difference between the plurality of target controlled output values and a future plurality of controlled output values.

11. The method of claim 10, wherein the filtration process is a cross flow ultrafiltration process.

12. The method of claim 10, wherein the flow of feed stock comprises a dairy product, in particular whey and the target component in the feed stock of the retentate flow is protein.

13. The method of any of claim 10, wherein the step of obtaining the plurality of target controlled output values further comprises:
determining a plurality of optimal future input values which optimize a first cost function, wherein the first cost function estimates a future efficiency of the filtration process according to one or more constraints; and
determining the plurality of target controlled output values from the control model based on the plurality of optimal future input values.

14. The method of claim 10, wherein the plurality of input values comprise a concentration factor comprising a first ratio of feed flow to outlet retentate flow and a water factor comprising a second ratio of water flow to feed flow.

15. A computer-readable medium storing instructions which, when executed by a control system comprising one or more processors, cause the system to optimize a filtration process performed at a cross flow membrane filtration (CFMF) device which separates a flow of feed stock and a flow of water into an outlet retentate flow and an outlet permeate flow, the method performed at a control system by causing the control system to perform steps comprising:
obtaining a plurality of controlled output values associated with the filtration process performed at the CFMF device, wherein the plurality of controlled output values comprise: (i) a product concentration value indicative of concentration of a target component of the feed stock in the outlet product flow, and (ii) a total concentration value indicative of concentration of components in the outlet product flow;
obtaining a plurality of disturbances associated with the CFMF device;
obtaining a control model of the CFMF device, wherein the control model estimates controlled output values from input values according to a state of the control model and the plurality of disturbances;
updating the state of the control model based on the plurality of controlled output values;
obtaining a plurality of target controlled output values;
determining a plurality of input values which optimize a first difference between the plurality of target controlled output values and a plurality of estimated controlled output values, wherein the plurality of estimated controlled output values are determined from the control model using the plurality of input values; and
causing the plurality of input values to be output to the CFMF device thereby decreasing a second difference between the plurality of target controlled output values and a future plurality of controlled output values.
